(19) United States
(12) Patent Application Publication
(10) Pub. No.: US 2014/0229501 A1
(43) Pub. Date: Aug. 14, 2014

(54) Comparing positional information

(71) Applicant: Frank Josefiak, Bonn (DE)

(72) Inventor: Frank Josefiak, Bonn (DE)

(73) Assignee: Deutsche Post AG, Bonn (DE)

(21) Appl. No.: 14/253,331

(22) Filed: Apr. 15, 2014

Related U.S. Application Data
(63) Continuation of application No. PCT/EP2012/070627, filed on Oct. 18, 2012.

(30) Foreign Application Priority Data
Oct. 20, 2011 (EP) 11185889.0

(51) Int. Cl. G06F 17/30

(52) U.S. Cl. CPC G06F 17/30424; G06F 17/30241
USPC 707/769; 707/758

(57) ABSTRACT

The invention relates, inter alia, to a method, a device, a system, a program and a storage medium for comparing a first piece of positional data with at least one second piece of positional data. The first piece of positional data is or can be assigned to a first transport unit or to a unit for generating positional data, while the second piece of positional data is or can be assigned to a second transport unit or to a location of a transport unit.

### CROSS-REFERENCE TO RELATED PATENT APPLICATIONS

This patent application is a continuation of PCT/EP2012/070627, filed Oct. 18, 2012, which claims priority to European Application No. 11185889.0, filed Oct. 20, 2011, the entire teachings and disclosure of which are incorporated herein by reference thereto.

### FIELD OF THE INVENTION

The invention relates, inter alia, to a method, an apparatus, a system, a program and a storage medium for comparing positional information.

### BACKGROUND OF THE INVENTION

In recent times (real time) monitoring of for example consignments, transport containers and/or transport vehicles has grown in importance. To this end, transport containers and transport vehicles are for example fitted with electronic devices, which capture parameters relevant to the monitoring and are able to send these wirelessly (for example via a mobile communications network) to a database of a database server, where they are stored in a corresponding data record. Also, for the tracking of consignments so-called scanning positions can be provided; immediately when a consignment passes such a scanning position, the scanning position is for example stored in a corresponding data record of the database as the last-known position of the consignment.

In order to monitor the progress of a consignment, a user is told for example an identifier for the consignment such as a tracking number. This allows the user to direct a search query to the database using the identifier. As the result of the search query the user is then for example shown the last-known position from the data record assigned to the consignment, for example the last scanning position of the consignment, on a map. However, a user is frequently interested in further information on the consignment, such as for example the current position of the consignment and the estimated time of arrival. In order to retrieve this data, the user can for example direct an additional search query to the database, identifying the transport vehicle, by which the consignment is being carried. As a result of the further search query the user is then for example shown the last-known position, for example the current position of the transport vehicle, and the estimated time of arrival of the transport vehicle at the destination from the data record assigned to the transport vehicle, on the map. This is disadvantageous, inter alia, because the user, in addition to the identifier of the consignment must also know the identifier of the transport vehicle and must make two queries. Usually the user has no idea about the various data sources and is not able to know them, so that he cannot combine the data in any case.

### SUMMARY OF THE INVENTION

The object of the invention was therefore, inter alia, to overcome the abovementioned disadvantages.

This object is achieved by a method according to claim 1, an apparatus according to claim 13, a system according to claim 14 and a program according to claim 15. Further embodiments can be learned from the dependent claims.

An exemplary method according to the invention, performed by at least one apparatus, comprises according to a first, second, third and fourth aspect of the invention, comparing a first piece of positional information with at least one second piece of positional information, in order to determine a similarity between the first piece of positional information and the second piece of positional information, wherein the first piece of positional information is assigned or can be assigned to a first transport unit or to a unit for generating pieces of positional information, and wherein the second piece of positional information is assigned or can be assigned to a second transport unit or a location for a transport unit.

According to the first aspect of the invention the exemplary method according to the invention further comprises, if as a result of the comparison a similarity between the first and the second piece of positional information is determined, associating the first transport unit with the second transport unit or with the location.

According to the second aspect of the invention the exemplary method according to the invention further comprises, if as a result of the comparison no similarity between the first and the second piece of positional information is determined, outputting of a piece of data concerning the result of the comparison.

According to the third aspect of the invention the exemplary method according to the invention further comprises influencing the generation of the first and/or second piece of positional information in dependence on the result of the comparison, for example if as a result of the comparison a similarity between the first and the second piece of positional information is determined and/or if as a result of the comparison no similarity between the first and the second piece of positional information is determined.

According to the fourth aspect of the invention the exemplary method according to the invention further comprises, if as a result of the comparison a similarity between the first and the second piece of positional information is determined, associating the unit for generating pieces of positional information with the second transport unit.

The first, second, third and fourth aspects of the invention shall be understood to be combinable aspects of the invention. An embodiment of the invention can thus implement the first aspect and/or the second aspect and/or the third aspect and/or the fourth aspect of the invention.

The method according to the invention can be performed by one or more data processing means. Examples of data processing means include a computer, a personal computer, a portable computer, a thin client, a personal digital assistant, a mobile telephone, a position transmitter and/or any other electronic device having at least a processor.

In particular, the method according to the invention can be performed by one or more servers, for example by one or more servers of a logistics data service provider, for example a consignment tracking service provider. The method can also be performed by the servers and at least by a client connected to the servers. A server shall in particular be understood to be a data processing unit in a network which, with one or more data processing units, communicates with the clients, via the network, in order to provide them with special services and/or computing power. In such a client-server architecture the special services and/or computing power provided by the server can be used by a plurality of clients, meaning that the clients themselves have to maintain less of their own computing power. A server and a client can designate both a data processing device and a program, run on the data processing device. The network is for example a local area network, a wide area network, a virtual network, a radio network, a telephone network and/or the Internet. Communication is for example wireless or wire-bound.

The servers may for example be database servers. Examples of a database server are a Microsoft SQL server, an SQL server, an Oracle server and a MySQL server. The servers can for example be part of a so-called cloud, which can provide data processing resources dynamically to various users via a network. A cloud shall in particular be understood to be a data processing infrastructure according to the definition of the National Institute for Standards and Technology (NIST) of the term “cloud computing”. An example of a cloud is the Microsoft Windows Azure platform.

A transport unit shall for example be understood to be a movable unit with a mobile, variable position, in particular a consignment, a transport container or a transport vehicle. Examples of a consignment are a letter, registered mail, a package, a parcel, a pallet or a cargo delivery. A transport container serves for example to accommodate one or more consignments. Examples of a transport container are a railway carriage, a container and a swap trailer. A transport vehicle serves for example for the transport of one or more consignments and/or one or more transport containers. Examples of a transport vehicle are a heavy goods vehicle (HGV), a motor car, a ship, an aircraft, a transporter or a train.

A location of a transport unit shall in particular mean a fixed position assignable (permanently and/or temporarily) to a transport unit. Examples of a location of a transport unit are a storage place, a transhipment point, a parking area, a rack location, a mooring point, a parking bay, a waiting position, a parking position or a container berth.

A unit for generating pieces of positional information shall in particular be understood to be an electronic device, which generates positional information, thus for example determines at least its position (for example a current position) and makes this available via a wireless or wire-bound connection, for example periodically or on request. This may involve, for example, a position or location transmitter, a scanner at a scanning position and/or a telematics unit. Determination of the position can for example be based on satellite positioning systems (for example GPS or Galileo) or mobile telephony (for example mobile network cell location). For example, the unit for generating pieces of positional information can be permanently or temporarily grouped with a transport unit, for example combined with the transport unit. The unit for generating pieces of positional information can for example be used for retrofitting transport units.

A piece of positional information shall in particular mean a specification of a spatial position, for example in the form of geographical latitude and longitude data, geofencing data or positional coordinates of a mobile communications system, or of a satellite navigation system (e.g. of the Global Positioning System (GPS) or of the Galileo-Systems, e.g. positional coordinates according to the World Geodetic System 1984 reference system). Geofencing shall in particular be understood as the subdivision of a geographical area into one or more (fixed) areas (so-called geofencing areas). The geofencing areas can for example be the same for all pieces of positional information that is assigned or can be assigned to transport units of a logistics company. For example, an action can be triggered when a transport unit leaves or enters a geofencing area, for example an alarm can be triggered and/or a piece of positional information generated for the transport unit. The geofencing area can be both static and dynamic. A piece of geofencing data describes for example in which of the geofencing areas the transport unit to which the piece of positional information is assigned or can be assigned is located. Apart from a position a piece of positional information can for example comprise further variables.

A piece of positional information can for example be a piece of Automatic Identification System (AIS) information and comprise some or all corresponding variables. AIS is a system which shall, through the exchange of pieces of positional information, navigation information and/or other inforamtion, inter alia improve shipping traffic safety. A piece of positional information can for example also be a piece of Automatic Dependent Surveillance (ADS) information and comprise some or all corresponding variables. ADS is a system which, through exchange of pieces of positional information, navigation information and/or other information can, inter alia, improve air traffic safety. In an ADS-B (ADS-Broadcast) system the pieces of information on an aircraft are for example broadcast at regular intervals and non-directionally.

A piece of positional information that is assigned or can be assigned to a transport unit can for example comprise the last-known position of the transport unit. A piece of positional information assigned or assignable to a transport unit can for example be updated at regular time intervals. A piece of positional information assigned or assignable to a transport unit can for example be updated at irregular time intervals, for example only if the position of the transport unit changes, for example if the transport unit leaves/enter a geofencing area. For example, the piece of positional information assigned or assignable to a transport unit is generated at regular or irregular time intervals, for example by the transport unit, for example by a position transmitter. The position transmitter can for example be integrated into the transport unit. The position transmitter of a transport vehicle is for example the vehicle's own position transmitter. For a consignment there may be a position transmitter in or on the consignment. For example, the position transmitter can be located in an envelope of a letter.

A piece of positional information assigned or assignable to a transport unit can for example contain a timestamp. The timestamp is for example updated when the piece of positional information is updated.

It is also conceivable for a piece of positional information assigned or assignable to a transport unit to contain one or more waypoints of an intended route for the transport unit. For example, such a route can be generated by a route planning system, for example by a route planning system of the logistics company responsible for the transport unit. Here a waypoint specifies a spatial position, for example in the form of geographical latitude and longitude data or positional coordinates of a mobile communications system or of a satellite navigation system or an address. The route can for example contain a specified sequence of waypoints (for example container trans-shipment centres), which are to be passed through in this order by the transport unit. The piece of positional information that is assigned or can be assigned to the transport unit can also contain one or more pieces of geofencing data—for geofencing areas, through which the route passes. For example the route can also specify a time for each waypoint and/or geofencing area, for example a time interval, when the waypoint is to be passed. For example it can be specified that a transport unit is to pass a waypoint and/or through a geofencing area on a particular day and/or between two particular times of that day. For example, each day a route planning system of a haulage contractor can generate a daily route for a transport vehicle, containing as waypoints a sequence of clients to be called at by the transport vehicle that day. In this case a piece of positional information that is assigned or can be assigned to the transport vehicle from the route planning system in each case comprises a waypoint and/or a corresponding piece of geofencing data (as the position of the transport vehicle) and the date of the respective day (as the timestamp).

A piece of positional information that is assigned or can be assigned to a location for a transport unit can for example contain a position of the location for a transport unit. A piece of positional information that is assigned or can be assigned to a location of a transport unit can for example be determined only once.

A piece of positional information can for example be stored in a data record in a database. A piece of positional information assigned or assignable to a transport unit can for example be stored in a data record that is assigned or can be assigned to the transport unit in a positional database, a vehicle fleet database, a telematics database, a consignment tracking database and/or a logistics database. A piece of positional information that is assigned or can be assigned to a location for a transport unit can for example be stored in a data record that is assigned or can be assigned to the location in a location database.

A data record that is assigned or can be assigned to a transport unit, to a unit for generating pieces of positional information or to a location can in addition to the piece of positional information comprise further characteristics of the transport unit, of the unit for generating pieces of positional information or of the location. Examples of such characteristics are an identifier, a type, an identification of the responsible logistics company, one or more time-related criteria, a current speed, an average speed, a temperature, a humidity level, a start address, a destination address, a planned route, a load and further pieces of positional information (e.g. pieces of positional information with a different timestamp).

The first piece of positional information and the second piece of positional information can originate from different data sources, for example from databases of different providers. For example, the pieces of positional information of transport vehicles can be stored in a different database from the pieces of positional information of consignments. For example the pieces of positional information assigned to the transport units of a logistics company are stored in data records in a telematics database of a telematics service provider. Manufacturers of HGVs or trailers, for example, offer such telematics services. The pieces of positional information assigned to the consignments, for which a logistics company is responsible, are for example stored in data records of a consignment tracking database of the logistics company or a consignment tracking service provider. In the comparison, therefore, information from the databases of various providers can be considered. This is an advantage as it allows, inter alia, a cross-provider and/or cross-database comparison. In addition this allows the (automatic) linking together of data records that previously could not be linked.

The first piece of positional information is for example generated by the first transport unit, the unit for generating pieces of positional information or a control station and is for example stored in a data record in a database. The second piece of positional information is for example generated by the second transport unit or control station or specified/determined for the location. Alternatively the second piece of positional information can for example also be generated by a route planning system. The second piece of positional information is for example stored in a data record in the database or in a further database. In particular, it is also conceivable that the first piece of positional information is more precise than the second piece of positional information, thus for example having a higher geographical resolution. For example, the first piece of positional information comprises the positional coordinates of a satellite navigation system, for example with a precision of at least 50 m, and the second piece of positional information comprises location, area or geofencing data, for example for a geofencing area of one or more square kilometres, for example an urban area or urban district.

For comparison of the first and the second piece of positional information it can be advantageous, to convert the positions indicated in the pieces of positional information to a standard format (for example a standard data format). For example, an address can be converted into a piece of geographical longitude and latitude data. A location (such as Cologne or Paris) can for example be converted into a piece of geofencing data, indicating the geofencing area containing the location. Such a conversion can for example be performed by a comparison with a database.

The comparison of the first piece of positional information with the at least one second piece of positional information shall be understood to mean that the first piece of positional information in each case is compared with one or more second pieces of positional information. If the first piece of positional information is compared with a plurality of second pieces of positional information, the first piece of positional information can for example be compared with each of the second pieces of positional information individually. For example, as a result of the comparison, the existence or not of a similarity between the first piece of positional information and the second pieces of positional information for each of the second pieces of positional information is individually determined in each case. Then for example the most similar piece of positional information can be determined. It is also conceivable that the most similar pieces of positional information are determined, for example for each type of transport unit the respective most similar piece of positional information being determined. For example, for a first piece of positional information that is assigned or can be assigned to a letter the respective most similar second piece of positional information can be determined, which is assigned or can be assigned to a transport container and a transport vehicle. This is an advantage in particular if the similar second pieces of positional information are assigned or can be assigned to different second transport units.

The comparison can also be repeated in the form of an iterative process of elimination, until as the result of the comparison only a similarity between the first piece of positional information and one of a plurality of second pieces of positional information is determined. For example, as the result of a first comparison a similarity between the first piece of positional information and a plurality of second pieces of positional information that are or can be assigned to different second transport units can be determined. Subsequently a further first piece of positional information that is assigned or can be assigned to the first transport unit is for example compared only to second pieces of positional information that are or can be assigned to the different second transport units. This method can be carried out until only a similarity between a first piece of positional information that is assigned or can be assigned to the first transport unit, which was used for the most recently performed comparison, and a second piece of positional information, which is assigned or can be assigned to one of the various second transport units, is determined. In this way the number of second pieces of positional information to be taken into account or second transport units in question is gradually reduced. This is also advantageous if the similar second pieces of positional information are assigned or can be assigned to different second transport units.

In the comparison, for example, only pieces of positional information with a timestamp that falls within a defined interval of time around the timestamp of the first piece of positional information are considered as second pieces of positional information. Examples of such a defined interval of time are 1 second, 1 minute, 5 minutes, 1 hour, 12 hours, 1 day or several days. It is also conceivable that in the comparison, for example, in each case only the piece of positional information with the most recent timestamp that is assigned or can be assigned to a transport unit or a location is taken into account as the second piece of positional information. In this way a pre-selection from the available pieces of positional information is already made, so that for example the number of second pieces of positional information and thus the computing time for the actual comparison is reduced. If the pieces of positional information that are or can be assigned to a transport unit or a location do not have a timestamp, for example all or none of the pieces of positional information will be taken into account.

For example, during the comparison of the first piece of positional information with the second piece of positional information a similarity can be determined, for example calculated. For example, a degree of similarity can be determined for one or more of the variables comprised in the pieces of positional information. For example, a degree of similarity is determined at least for the positions comprised in the pieces of positional information. Examples of measures of similarity are Simple Matching, Hamman or Tanimoto, Dice, Jaccard, Kulczynskl, Ochiai, Braun, Simpson, Sneath Kappa, Phi and Yule. A degree of similarity usually has a value of greater than or equal to 0 and less than or equal to 1. For a degree of similarity with a value of 0, for example, there is no similarity between the variables compared. For a degree of similarity with a value of 1, for example, the variables compared are equal. A similarity between the compared pieces of positional information is determined as the result of the comparison for example if the degree of similarity exceeds a threshold value. Otherwise the result of the comparison for example is that no similarity between the pieces of positional information is determined. The threshold value is for example greater than or equal to 0.5; preferably the threshold value is 0.75 or 0.9. The most similar piece of positional information is for example the piece of positional information, for which the greatest degree of similarity results.

Further possible methods that can for example be used, to determine the similarity of pieces of positional information and/or a degree of similarity, are multi-variant methods of cluster analysis, for example similarity measurements using hierarchical methods, such as the Ward method or the Single Linage method.

The pieces of positional information compared are for example similar, if the variables comprised in the first piece of positional information are similar to the variables comprised in the second piece of positional information, in particular with a spatial or temporal similarity. The pieces of positional information compared are in particular similar if the position comprised in the first piece of positional information is at least located in the vicinity of the position comprised in the second piece of positional information and/or if the timestamps of the pieces of positional information essentially correspond, e.g. are within an interval of time of 1 second, 1 minute or 5 minutes. The vicinity can for example be a geofencing area. The pieces of positional information compared are for example similar, if the position comprised in the first piece of positional information corresponds with the position comprised in the second piece of positional information. Otherwise for example no similarity exists between the pieces of positional information compared. This is advantageous, inter alia, in determining whether the first transport unit is (or was) spatially at least in proximity to the second transport unit or the location.

In order to increase the precision of the result, for example further pieces of positional information that are assigned or can be assigned to the first transport unit or the unit for generating pieces and to the second transport unit or the location can be—for example in each case individually—compared, for example first and second pieces of positional information with a more recent and/or an older timestamp. It can for example be specified that at least two or more individual comparisons must be performed, before, as the result of the comparison, a similarity or no similarity is determined. This is advantageous, inter alia, for avoiding a false result due to a random (individual) similarity. So instead of a comparison of only one first piece of positional information with a second piece of positional information a comparison is then made between a number of first pieces of positional information and a number of second pieces of positional information. Alternatively it is also possible, for the pieces of positional information in each case to also contain more than one spatial position, for example a plurality of spatial positions, for example a number of spatial positions captured at different time points (for example equidistant time points), for example in the form of a route taken or planned. Each of the spatial positions can then for example be assigned its own timestamp. Inherent in the comparison of the first piece of positional information with the second piece of positional information is then a comparison between two groups of spatial positions (for example two routes or route sections).

According to the first aspect of the invention then, for example, if as a result of the comparison (and/or a plurality of individual comparisons) a similarity is determined, the first transport unit can be associated with the second transport unit or with the location. Here association shall in particular mean at least a logical bringing-together of the first transport unit and the second transport unit or the location. This is advantageous, inter alia, in order to automatically create a logical link between the first transport unit and the second transport unit or the location, if the first transport unit is (or was) at least located in proximity to the second transport unit or the location. So far, association of the first transport unit with the second transport unit or the location had to be performed manually, which was considerably more complex and error-prone.

For example, the first piece of positional information can be obtained as the result of a search query by a user to a consignment tracking service provider regarding the position of a consignment of the user. For example, the first piece of positional information is assigned or can be assigned to the consignment and comprises the last-known position of the consignment. For example, the last-known position of the consignment is a scanning position on a loading bay. The first piece of positional information is for example stored in a data record of a consignment tracking database of the consignment tracking service provider. For example the first piece of positional information is individually compared with a plurality of second pieces of positional information. The second pieces of positional information for example in each case are assigned or can be assigned to a transport vehicle of the logistics company responsible for the consignment and comprise the position of the respective transport vehicle at the time of loading of the consignment. The second pieces of positional information are for example stored in a data record in a telematics database for transport vehicles. By comparing the first piece of positional information with each of the second pieces of positional information, in this example the transport vehicle, which was on the same loading bay at the time of loading of the consignment and on which the consignment was thus loaded, can be determined. This transport vehicle can then be automatically associated with the consignment. For example, as the result of the search query the last-known position of the transport vehicle can be output to the user as the position of the consignment. For example, the transport vehicle generates at regular or irregular intervals a piece of positional information with the current position of the transport vehicle and sends this to the telematics database server, so that as the result of the search query the last-known position, for example the current position of the transport vehicle is output to the user as the position of the consignment. This represents a considerably more precise indication of the position of the consignment than an indication of the last scanning position. In other words, the result of the search query relating to the consignment can be automatically enriched with information on the transport vehicle and then output to the user.

Furthermore, the piece of positional information that is assigned or can be assigned to the consignment and/or the data record that is assigned or can be assigned to the consignment can be automatically linked to the piece of positional information that is assigned or can be assigned to the transport vehicle and/or to the data record that is assigned or can be assigned to the transport vehicle. For example, the piece of positional information that is assigned or can be assigned to the consignment can refer to the piece of positional information that is assigned or can be assigned to the transport vehicle that in each case has the most recent timestamp. This is, inter alia, advantageous, in order to be able to (automatically) create a permanent or at least temporary link between the data relating to the consignment.

Furthermore, the first aspect of the invention is for example advantageous if the transmission of the pieces of positional information generated by a transport unit is prevented by another transport unit. This is the case for example if a container with a position transmitter is located in the belly of a ship. For example the outer shell of the ship then represents a Faraday cage, meaning that positional information cannot be transmitted by radio from the container. By comparing pieces of positional information of the container and of the ship, the container can be automatically associated with the ship. For example the respective current piece of positional information of the ship or the data record of the ship can be linked with the data record of the container.

According to the second aspect of the invention, a corresponding message can be output for example if as the result of the comparison (and/or a plurality of individual comparisons), no similarity is determined. The pieces of positional information compared (in other words the first and the second pieces of positional information) can for example in each case be assigned or assignable to a transport unit from a group of transport units. A group of transport units can for example be made up of the transport vehicles in a convoy, a transport vehicle and one or more transport containers transported by the transport vehicle or a plurality of (individual) consignments shipped together. The second aspect of the invention is, inter alia, advantageous to allow monitoring if the group of transport units has been spatially separated (e.g. isolated). For example, the comparison of the first piece of positional information with the second pieces of positional information can be performed automatically, if the first piece of positional information changes, for example if the first piece of positional information is updated. For example, the dispatcher responsible for the group of transport units can be automatically notified if the group has been separated.

According to the third aspect of the invention, for example, in dependence on the result of the comparison (and/or a plurality of individual comparisons) it is possible to influence the generation of the pieces of positional information. This is advantageous, inter alia, in order to at least reduce the generation of redundant pieces of positional information, for example by transport units that at least temporarily form a spatial group. Transport units form for example a spatial group if they are spatially connected to one another and/or spatially associated and/or move or can move in the same way, for example if they are transported together and/or if a transport unit transports another transport unit, for example accommodates it or is secured in or on it.

For example, the first piece of positional information can be assigned to a transport container and stored in a data record in a telematics database. The transport container can for example generate at regular time intervals a piece of positional information with the current position of the transport container and send this to the telematics database server. For example, the second piece of positional information can be assigned to a transport vehicle and stored in a data record in a further telematics database. The transport vehicle can for example similarly generate a piece of positional information with the current position of the transport container at regular time intervals and send this to the further telematics database server. By comparing the first piece of positional information with the second piece of positional information (or preferably a plurality of individual comparisons of the respective up-to-date first piece of positional information with the respective up-to-date second piece of positional information) in this example it can be determined if the transport vehicle is transporting the transport container. This is the case, if as a result of the comparison (or a plurality of individual comparisons), a similarity is determined. In this case the frequency, with which the transport container generates a piece of positional information and sends it to the telematics database server, can at least be reduced. For example, the server can send a corresponding signal to the transport container and for example instruct the position transmitter of the transport container to reduce the frequency.

For example, the data record assigned to the transport container can be linked with the data record assigned to the transport vehicle. The current piece of positional information is for example the piece of positional information with the last-known position. For example, the data record assigned to the transport container can refer to the current piece of positional information of the data record assigned to the transport vehicle. As a result there are no disadvantages from reducing the frequency, since the data record assigned to the transport container is enriched with the current piece of positional information of the transport vehicle.

According to the fourth aspect of the invention the unit for generating pieces of positional information (for example a position transmitter) can, for example if as a result of the comparison (and/or a plurality of individual comparisons) a similarity is determined, be associated with the second transport unit (for example a container). In this way the pieces of positional information generated by the unit for generating pieces of positional information for example are assigned or can be assigned to the second transport unit. This is for example advantageous when fitting or retrofitting transport units with units for generating positional information, since manual “linking” of the unit for generating the pieces of positional information with the transport unit, for example the capture of an identifier of the transport unit (for example via a barcode reader) and inclusion of this identifier in a data record assigned to the unit for generating the pieces of positional information and/or the capture of an identifier of the unit for generating the pieces of positional information and the inclusion of this identifier in a data record assigned to the transport unit, can be dispensed with.

For example, a transport unit can thus be fitted or retrofitted with a unit for generating pieces of positional information, without the need for manual (logical) linking of the pieces of positional information generated by the unit with the pieces of positional information of the transport unit. For example, from the pieces of positional information generated by the unit for generating pieces of positional information it is known that the unit for generating pieces of positional information has passed certain positions in a certain sequence. By comparing these first pieces of positional information with the second pieces of positional information that are or can be assigned to the transport unit, for example from a route planning system (for example a planned route, for example a series of visits to different customers with correspondingly different positions or in different geofencing areas), it can for example be determined that the transport unit has moved in a similar way as the unit for generating the piece of positional information and therefore that there is a high probability that the transport unit was fitted or retrofitted with the unit for generating pieces of positional information. In this case the unit is for example associated with the transport unit. For example, the pieces of positional information generated by the unit are +linked with the pieces of positional information of the transport unit. For example, the data record assigned to the unit can be linked with the data record assigned to the transport unit.

Determination of the similarity can take place here by comparison of just one position in the first piece of positional information and just one position in the second piece of positional information, or by comparison of a group of positions (for example a route or a route section) in the first piece of positional information and a group of positions in the second piece of positional information. In determining the similarity a plurality of first pieces of positional information of the unit for generating pieces of positional information can also be compared with a plurality of second pieces of positional information of the transport unit. This can for example be necessary in order to allow an unambiguous association of the unit for generating pieces of positional information with the second transport unit. For example, a plurality of comparisons in the form of the iterative process of elimination described above can be carried out, if as a result of a first comparison a similarity between the first piece of positional information and a plurality of second pieces of positional information that are assigned or can be assigned to different second transport units is determined. This allows for example clear identification of the second transport unit, which has been retrofitted with a unit for generating pieces of positional information, and associating it with this unit for generating pieces of positional information.

An exemplary apparatus according to the invention comprises means for performing the method according to the invention. The apparatus is for example a data processing apparatus, for example a server or a client. The apparatus can for example also be in the form of a cloud.

An exemplary apparatus according to the invention comprises for example at least a processor and a memory, wherein the memory stores a program comprising program instructions, wherein the memory and the program are configured to, with the processor, to cause the apparatus at least to perform the method according to the invention, when the program is run on the processor. The apparatus is for example software-based, in order to be able to perform the method. Here, software-based shall in particular be understood to be the preparation of the apparatus necessary to be able to perform a method in the form of a program on the processor.

A processor shall be understood to be, inter alia, one or more control units, microprocessors, micro control units such as microcontrollers, digital signal processors (DSP), Application Specific Integrated Circuits (ASIC) or Field Programmable Gate Arrays (FPGA).

A memory is for example a program memory and/or a main memory of the processor. A program memory shall be understood to be, inter alia, a non-volatile memory, and a main memory shall be understood to be, inter alia, a volatile or a non-volatile memory, in particular a random access memory (RAM) and/or a Flash memory. Non-volatile memories are, for example, random access memories (RAM) such as NOR Flash memories, sequential access memories such as NAND-Flash memories and/or read only memories (ROM) such as EPROM, EEPROM, or ROM memories. The memory can for example be in tangible form.

An exemplary system according to the invention comprises one or more apparatuses with means for performing the method according to the invention. For example, the system comprises one or more apparatuses according to the invention, or one or more apparatuses (for example a Server and a client), which in combination provide the functions according to the invention.

An exemplary program according to the invention comprises program instructions, wherein the program instructions cause a processor to perform the method according to the invention, when the program is run on the processor. A program is for instance distributable over a network such as a local area network, a wide area network, a virtual network, a radio network, a telephone network and/or the Internet. A program can at least be in part software and/or firmware of a processor. For example, the program according to the invention is stored in a memory of the apparatus according to the invention.

An exemplary storage medium according to the invention comprises the program according to the invention. The storage medium is for example a computer-readable storage medium, containing the program according to the invention and which for example is in the form of a magnetic, electric, electromagnetic, optical and/or other type of storage medium. The storage medium can in particular be a physical and/or tangible storage medium. The storage medium is for example portable or permanently installed in an apparatus. “Computer-readable” shall in particular be understood to mean that the storage medium can be read (out) and/or written to by a computer or a data processing apparatus, for example by a processor. The storage medium is for example a program memory of a processor.

In the following, exemplary embodiments of the invention are described, which are directed to further exemplary features of the method according to the invention, the apparatus according to the invention, the system according to the invention, the program according to the invention and the storage medium according to the invention. In particular here through the description of an additional method step of the method according to the invention means for performing the method step of the apparatus according to the invention and a corresponding program instruction of the program according to the invention shall also be considered to be disclosed. The same shall also apply to the disclosure of a means for performing a process step or a program instruction, for example the disclosure of a means for performing a process step shall also be understood as a disclosure of the corresponding process step and a corresponding program instruction.

According to an embodiment of the invention, the method according to the invention further comprises the obtaining of the first piece of positional information. For example the first piece of positional information is acquired as the result of a search query by a user. For example, the first piece of positional information is acquired from the first transport unit. For example, the first piece of positional information is automatically compared with the second piece of positional information, as soon as the first piece of positional information is acquired.

According to an embodiment of the invention each piece of positional information assigned or assignable to a transport unit comprises a position of the transport unit, and/or each piece of positional information that is assigned or can be assigned to the unit for generating pieces of positional information comprises a position of the unit for generating pieces of positional information. As outlined above, the position can for example be specified in the form of geographical latitude and longitude data or positional coordinates. When comparing the pieces of positional information for example at least the position comprised by the first piece of positional information is compared with the position comprised by the second piece of positional information. This is, inter alia, advantageous, in order to determine if the first transport unit or the unit for generating pieces of positional information (at least with a high probability) is (or was) at least located in the vicinity of the second transport unit or the location.

According to an embodiment of the invention each piece of positional information that is assigned or can be assigned to a transport unit or the unit for generating pieces of positional information further comprises a speed, an average speed, a direction of movement, an accuracy of the piece of positional information and/or a timestamp. These variables can for example be determined by the transport unit or by the unit for generating pieces of positional information, for example be measured. The position, speed and direction of movement can for example be specified in the form of a velocity vector in the piece of positional information, wherein the base point of the velocity vector corresponds to the position, the direction of the velocity vector corresponds to the direction of movement and the length of the velocity vector corresponds to the speed.

It is also possible for the variables to at least in part be determined after generation of the piece of positional information, for example by a database server and/or in the comparison of the pieces of positional information. For example, using the timestamp of two consecutive pieces of positional information assigned to a transport unit and the pieces of positional information comprised therein, an average speed of the transport unit can be calculated. Only from the pieces of positional information for example a direction of movement of the transport unit can be determined.

For example, in the comparison of the pieces of positional information, apart from the position comprised in the first piece of positional information and the position comprised in the second piece of positional information more of the stated variables can be compared with one another. The accuracy of the piece of positional information can for example be taken into account in an assessment of the degree of similarity and/or in determining the degree of similarity. This is, inter alia, advantageous, in order to increase the accuracy of the result of the comparison, for example the degree of similarity.

For example, as a result of the comparison of two pieces of positional information, assigned to two intersecting transport vehicles, a (random) similarity of the pieces of positional information may be determined if the compared pieces of positional information comprise only the current position of the transport vehicles. On the other hand, as a result of the comparison, no similarity of the pieces of positional information can be determined, if the pieces of positional information compared contain the current position and the direction of movement of the transport vehicles. In addition, the timestamp of the pieces of positional information, particularly in such transport units, moving at (high) speed, can be an important criterion for the similarity and/or for determining the degree of similarity.

According to an embodiment of the invention the first and the second pieces of positional information are similar, if the position comprised in the first piece of positional information is located in a defined vicinity around the position comprised in the second piece of positional information. An example of a defined vicinity is for example a circular or rectangular area, in the centre of which the position comprised in first piece of positional information is located. The diameter of such an area is for example 1 metre, 10 metres, 20 metres, 50 metres, 100 metres or 500 metres. The diameter (or, in the case of a rectangular area, e.g. the edge length) is for example dependent upon the accuracy of the positions indicated in the pieces of positional information. The defined vicinity can for example be a geofencing area. This is, inter alia, advantageous in order to determine if the first transport unit or the unit for generating pieces of positional information (at least with a high probability) is (or was) at least located in the vicinity of the second transport unit or the location.

According to an embodiment of the invention the first and the second piece of positional information are similar if the variables comprised in the pieces of positional information are similar, for example statistically similar. As outlined above, during the comparison of the first piece of positional information with the second piece of positional information a degree of similarity for one or more of the variables comprised in the pieces of positional information can be determined.

A similarity between the pieces of positional information compared is for example determined as a result of the comparison, if the degree of similarity exceeds a threshold value. Otherwise as a result of the comparison for example no similarity between the pieces of positional information is determined. The threshold value is for example greater than or equal to 0.5, preferably the threshold value is 0.75 or 0.9. It is also conceivable that other or additional statistical methods are applied to determine the similarity.

According to an embodiment of the invention the first piece of positional information is generated and/or obtained by a control unit, the first transport unit or the unit for generating pieces of positional information, and the second piece of positional information is generated and/or obtained by the second transport unit. The control unit is for example a mobile or fixed scanning position. As soon as the first transport unit passes the control unit, the control unit can generate the first piece of positional information with the scanning position as the position of the transport unit. The first piece of positional information can be sent by the control unit to a server as the current piece of positional information and can be received at the server. Alternatively, the first piece of positional information with the current position of the first transport unit can be generated by the first transport unit, for example by a position transmitter of the transport unit. The first piece of positional information can be sent by the first transport unit as the current piece of positional information to the server and can be received at the server. Alternatively, the first piece of positional information with the current position of the unit for generating pieces of positional information can be generated by this unit. The first piece of positional information can be sent by the unit for generating pieces of positional information to the server and can be received at the server. The second piece of positional information with the current position of the second transport unit can be generated by the second transport unit, for example by a position transmitter of the transport unit. The second piece of positional information can be sent by the second transport unit as the current piece of positional information to the server and received at the server. As outlined above, the first piece of positional information can for example be automatically compared with the second piece of positional information, as soon as the first piece of positional information is obtained. This is, inter alia, advantageous, in order to (automatically) determine if the first transport unit or the unit for generating pieces of positional information (at least with a high probability) is (or was) at least located in the vicinity of the second transport unit.

According to an embodiment of the invention a data record is assigned or can be assigned to each transport unit or to the unit for generating pieces of positional information, wherein each data record comprises at least a piece of positional information (e.g. at least the current piece of positional information) of the transport unit that is assigned or can be assigned to it or of the unit for generating pieces of positional information that is assigned or can be assigned to it, and wherein a first data record with the first piece of positional information is assigned or can be assigned to the first transport unit or to the unit for generating pieces of positional information and wherein a second data record with the second piece of positional information is assigned or can be assigned to the second transport unit.

According to an embodiment of the invention the association comprises the at least partial linking of the first data record with the second data record. For example, the data records can be linked by a reference to the respective other data record (e.g. by a pointer, a data record number or an identifier). For example, the data records can at least in part be combined in a new data record. The linking of the data records is, inter alia, advantageous, in order that when accessing one of the data records the other data record can be accessed automatically and quickly, in particular without a further similarity check.

The data records can firstly be permanently linked. This is advantageous, for example, if the first transport unit or the unit for generating pieces of positional information and the second transport unit form a permanent spatial group. In this case the possibly computer-intensive comparison only has to be performed once. For example, the data record assigned to a refrigerated body of an HGV can be permanently linked with the data record assigned to the tractor unit. The data record assigned to the refrigerated body can for example contain data on the refrigeration temperature. The data record assigned to the tractor unit can for example contain data on the speed, the planned route and consumption. In addition, for example, the data record of a second transport unit retrofitted with a unit for generating pieces of positional information can be permanently linked with the data record that is assigned or can be assigned to the unit for generating pieces of positional information, so that the position of the second transport unit can be monitored with the help of the pieces of positional information generated by the unit for generating pieces of positional information.

On the other hand the data records can be temporarily linked. For example, the data records can remain linked only for as long as the first transport unit or the unit for generating pieces of positional information and the second transport unit form a spatial group. If the first transport unit or the unit for generating pieces of positional information and the second transport unit are separated, the linking can for example can be reversed, preferably automatically. Through an automatic comparison of the respective current first piece of positional information and the respective current second piece of positional information it can for example be monitored if the first transport unit or the unit for generating pieces of positional information and the second transport unit form a spatial group. For example, it is possible to monitor if the first transport unit and the second transport unit are located in the same geofencing area, respectively, for example by a comparison of geofencing data in the first and second pieces of positional information and/or by converting pieces of positional information in the first and/or second pieces of positional information into geofencing data.

According to an embodiment of the invention the first data record is linked with the second data record in a way that the first data record at least comprises a reference to the second piece of positional information. This is, inter alia, advantageous for enriching the first data record with the second piece of positional information.

According to an embodiment of the invention the method according to the invention also comprises obtaining of a search query of a user concerning the first transport unit. In a client-server architecture, the user can for example enter the search query on a client. For example, the search query is sent by the client to a server of the consignment tracking service provider and is received there. The search query can for example concern the last-known position of the first transport unit. The search query can for example be truncated. For example, if the user enters the truncated search query “12345*”. The “*” in the truncated search query is a wildcard for any number of further characters. The search query “12345*” thus for example relates to the following character strings: “123450”, “12345ABC” and “123456789”.

According to an embodiment of the invention the method according to the invention also comprises enriching of pieces of information concerning the first transport unit with pieces of information concerning the second transport unit or the location, if as a result of the comparison a similarity between the first and the second pieces of positional information is determined, and outputting of the enriched pieces of information concerning the first transport unit as a result of the search query. The pieces of information concerning the first transport unit are for example stored in the first data record and the pieces of information concerning the second transport unit are for example stored in the second data record. The enriched pieces of information are made available in the client-server architecture for example by the server of the consignment tracking service provider for display at the client, for example sent to the client and displayed to the user on the client.

The enriching is, inter alia, advantageous in order to output further pieces of information that may be relevant to the search query as the result of the search query. For example, as the result of the search query, in addition to the pieces of information concerning the first transport unit, further pieces of information concerning the second transport unit are also output to the user. For example, the second transport unit is a tractor unit of a HGV with a refrigerated body. As the result of the search query for example pieces of information concerning the tractor unit, such as the speed and consumption, and pieces of information concerning the refrigerated body, such as the refrigeration temperature, can be output.

Furthermore, enriching is inter alia advantageous in order to improve the accuracy of the result of the search query. As outlined above, as the result of a search query concerning a consignment, for example the current position of the transport vehicle, can be output as the position of the consignment, rather than the imprecise indication of the last scanning position of the consignment.

According to an embodiment of the invention the first transport unit is a consignment, wherein the second transport unit is a transport container or a transport vehicle for the consignment, and wherein the pieces of information concerning the consignment are enriched with pieces of telematics information concerning the transport container or the transport vehicle. Examples of pieces of telematics information are operational variables such as the speed, the average speed, the consumption, the air humidity, the refrigeration temperature, the external temperature, the starting address, the destination address, the planed route and the load. The pieces of telematics information are for example stored in the second data record.

According to an embodiment of the invention the method according to the invention further comprises displaying of a map extract for the user. For example, the map extract is displayed to the user on a user data processing apparatus. The map extract can for example be stored on the user data processing apparatus, for example as a displayable graphic. In the client-server architecture, the map extract can be displayed to the user for example on a client. For example, the map extract can be made available for display to the client by a server of a map service provider and/or the consignment tracking service provider, for example as a displayable graphic. The map extract can be selected and/or changed by the user through user input.

A map extract shall in particular be understood to be a graphic representation of part of the earth's surface, preferably a representation to scale. A map extract comprises for example at least one representation in the correct position of the geographical objects located on the earth's surface, such as streets, railway lines, large buildings, the contours of places and/or other technical facts such as (political) boundaries, water or power lines. Examples of map extracts are street maps, nautical maps and topographic maps.

According to an embodiment of the invention the enriched data are shown on the map extract at the position comprised in the first and/or second piece of positional information. The data can also be displayed in a corresponding geofencing area, for example, in the centre of the geofencing areas. For example, a pictogram corresponding to the first or second transport unit is displayed at the position. Examples of possible pictograms are an HGV pictogram, a ship pictogram, a container pictogram, a swap bodies pictogram, a letter pictogram, a train pictogram, an aircraft pictogram and/or a package pictogram. For example, as a result of a search query concerning a consignment for example a pictogram corresponding to the transport vehicle can be displayed at the last-known position of the transport vehicle on the map extract. In this way the user automatically receives information on where the consignment currently is and how it is being transported.

Apart from a pictogram for example further information can be displayed and/or be activated for display, for example through user input. For example, the display of the information is updated at regular intervals, so that a movement of the transport units can be displayed. The previous positions can for example likewise be displayed and/or be activated for display, for example through user input. The planned route can for example similarly be displayed and/or be activated for display, for example through user input. This is, inter alia, advantageous, to allow a clear and user-friendly output of the information.

According to an embodiment of the invention the method according to the invention further comprises determining and/or outputting of further pieces of information of relevance to the first transport unit as the result of the search query and/or the outputting of further pieces of information of relevance to the second transport unit or the location as a result of the search query, if as a result of the comparison a similarity between the first and the second piece of positional information is determined.

For example, relevant traffic, weather, airport and/or sea port information is output, for example they are displayed on the map extract. Selection of the further information can for example take place in dependence on the characteristics of the first and/or second transport unit or the location, for example in dependence on the type. Selection and output of the further information can for example take place automatically. Selection and output of the further information can for example take place on the basis of user input, for example the user can select that relevant traffic information is to be displayed.

Traffic information is for example relevant, if at least one of the pieces of positional information is assigned to a HGV. For example, in this case only traffic information relevant to the planned route of the HGV may be output. Weather data is for example important in particular if at least one of the pieces of positional information is assigned to a ship. For example, in this case only weather information relevant to the planned route of the ship may be output. Furthermore, in this case for example sea port information (e.g. handling time, free berths and so on) for the planned destination port of the ship can be selected and displayed. In this way only information that is at least with a high probability of interest to the user is displayed. This is, inter alia, advantageous, in order to reduce the necessary data traffic and for example to allow in a client-server architecture the use of clients with a slow network connection. The provision of further information can also be subject to charges, time-intensive and/or computer-intensive.

According to an embodiment of the invention the method according to the invention further comprises reducing a frequency with which the first and/or second piece of positional information is generated, if as a result of the comparison a similarity between the first and the second piece of positional information is determined, and/or increasing the frequency if as a result of the comparison no similarity between the first and the second piece of positional information is determined. This is, inter alia, advantageous, in order to at least reduce the generation of redundant pieces of positional information for example by transport units forming a spatial group. In this way the battery of the transport units can also be spared.

For example, the frequency with which the first piece of positional information is generated, can be reduced for as long as the first transport unit and the second transport unit form a spatial group. As soon as the first transport unit and the second transport unit are separated, the frequency with which the first piece of positional information is generated, can for example be increased. Through an automatic comparison of the respective current first piece of positional information and the respective current second piece of positional information for example it is possible to monitor if the first transport unit and the second transport unit form a spatial group. For example, it is possible to monitor if the first transport unit and the second transport unit in each case are located in the same geofencing area.

According to an embodiment of the invention the first transport unit is a first individual consignment and the second transport unit a second individual consignment, wherein the first individual consignment and the second individual consignment are dispatched together (e.g. are to be dispatched as a joint consignment), and wherein an isolation alarm is activated if as a result of the comparison no similarity between the first and the second piece of positional information is determined.

According to an embodiment of the invention the system according to the invention comprises one or more data sources, and/or one or more data interfaces for accessing the data sources. Examples of data sources are one or more position transmitters (specific to the transport units), fixed or mobile control stations and databases, such as positional information bases, telematics databases, fleet databases, consignment tracking databases and logistics databases.

According to an embodiment of the invention the apparatus according to the invention comprises a network interface to connect to a network. A network interface is for example a wire-bound network interface, such as an Ethernet network interface or a DSL modem, or a wireless network interface, such as a UMTS network interface or an IEEE 802.11 network interface. The network is for example a local area network, a wide area network, a virtual network, a radio network, a telephone network and/or the Internet.

Further advantageous configurations of the invention can be learned from the following detailed description of a number of exemplary embodiments of the invention, in particular in connection with the figures. The figures shall nevertheless serve solely for clarification, and not for determining the scope of protection of the invention. The figures are not to scale and shall merely be an exemplary reflection of the general concept of the invention. In particular, features comprised in the figures shall in no way be considered necessary components of the invention.

### BRIEF DESCRIPTION OF THE DRAWINGS

The figures show as follows:

FIG. 1: a block diagram of an exemplary embodiment of a system according to the invention;

FIGS. 2a and 2b: a block diagram of an exemplary embodiment of a server and a client;

FIGS. 3a to 3d: flow diagram with process steps of exemplary embodiments of the method according to the invention; and

FIGS. 4a to 4f: schematic representations of a map extract shown on a display unit of the client;

FIG. 5: a block diagram of an exemplary embodiment of a storage medium according to the invention.

### DETAILED DESCRIPTION OF A NUMBER OF EXEMPLARY EMBODIMENTS OF THE INVENTION

The invention is described in the following using exemplary embodiments.

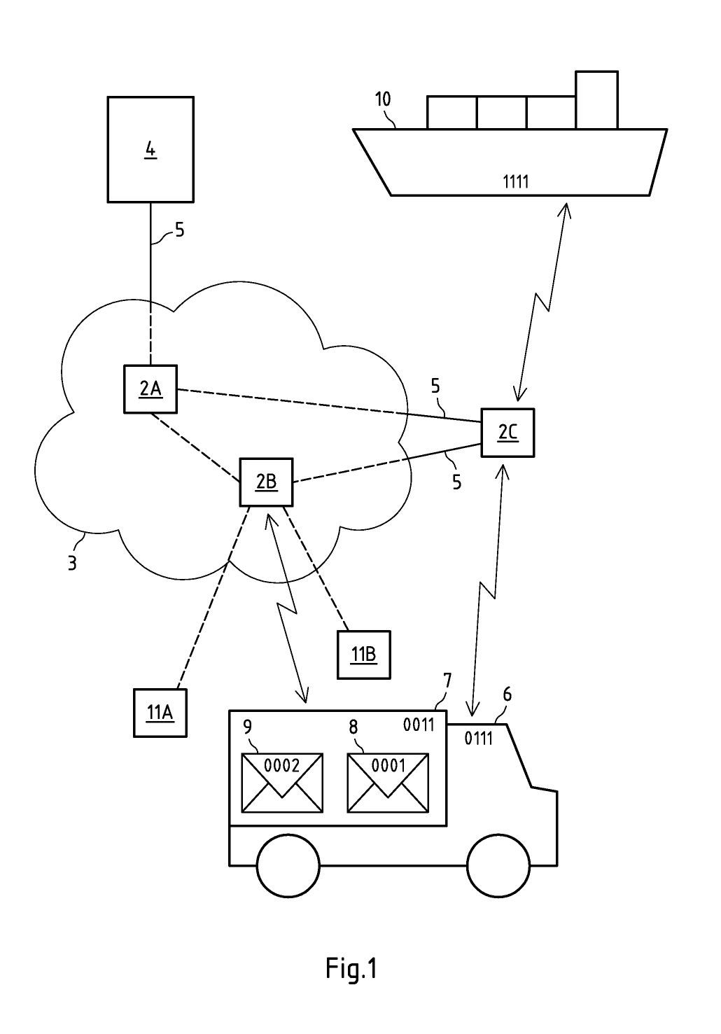

FIG. 1 shows a block diagram of an exemplary embodiment of a system according to the invention 1. System 1 comprises, inter alia, servers 2A, 2B and 2C.

Server 2A is an application server of a consignment tracking service provider and provides a consignment tracking service for one or more users. Server 2B is a database server of the consignment tracking service provider and provides a consignment tracking database with consignment tracking data records for the users of the consignment tracking service.

Servers 2A and 2B are part of a cloud 3. In addition to servers 2A and 2B, cloud 3 can comprise further servers such as for provision of the consignment tracking service and/or further services. An example of a further service is a route planning system.

Server 2C is a database server of a telematics service provider distinct from the consignment tracking service provider and provides a telematics database with telematics data records for one or more users.

Client 4 belongs to a user of the consignment tracking service and the telematics service and is connected via a network 5 at least with server 2A and/or cloud 3. Client 3 is preferably a personal computer, a portable computer or a thin client.

Server 2C is similarly connected via the network 5 at least with server 2A and/or cloud 3. The network 5 is preferably the Internet.

Furthermore, the system 1 comprises a tractor unit 6, a container 7, a letter 8 and 9, a scanning position 11A and 11B and a container ship 10.

The tractor unit 6 and the ship 10 are each assigned a telematics data record in the telematics database on the server 2C. Both the tractor unit 6 and the ship 10 generate at regular intervals (the tractor unit 6 twice per minute and the ship 10 once per hour) pieces of positional information with the respective current position, current speed and a timestamp and send the pieces of positional information via a wireless connection to the server 2C, for example via a radio link. The piece of positional information of the ship 10 is for example an Automatic Identification System (AIS) piece of information and comprises all corresponding variables. The pieces of positional information are stored in the telematics data record assigned to the tractor unit 6 or the ship 10.

The container 7, the letter 8 and the letter 9 are for example each assigned a consignment tracking data record in the consignment tracking database on the server 2B. The container 7 generates at regular intervals (twice per hour) positional information with the respective current position and a timestamp and sends the piece of positional information via a wireless connection to the server 2B, for example via a radio link. The container 7 is positioned on the trailer of the tractor unit 6. For the letters at scanning positions 11A and 11B pieces of positional information with the respective scanning position are generated and sent to the server 2B via the network 5, immediately when a letter passes the scanning positions. For example, a barcode on the letter is automatically or manually scanned, when it passes a scanning position, for example upon loading in the container 7. The scanning positions are in each case arranged on loading bays. The pieces of positional information are stored in the consignment tracking data record assigned to the container 7, the letter 8 or the letter 9.

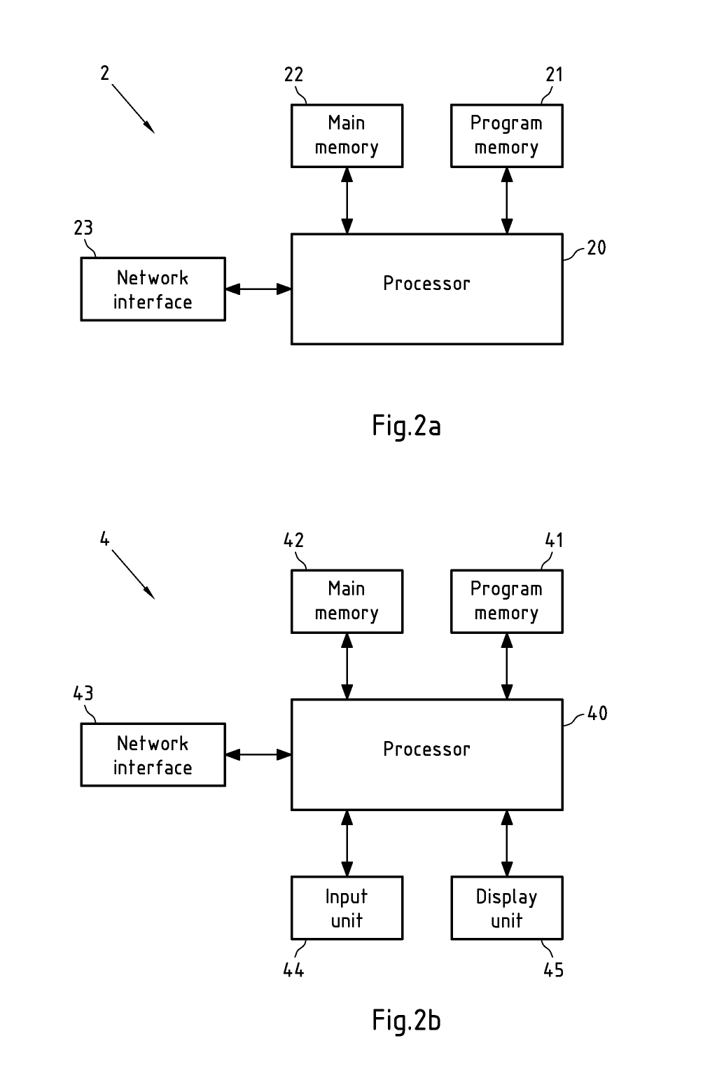

FIG. 2a shows a block diagram of an exemplary embodiment of the server 2A. Server 2A is an exemplary embodiment of an apparatus according to the invention.

Processor 20 of server 2A performs program instructions, which are stored in program memory 21, and stores for example intermediate results or similar in main memory 22.

In addition processor 20 controls network interface 23, by means of which server 2A is able to connect with the network 5.

Furthermore, server 2A can have additional units, such as for example an input and/or output unit, e.g. a keyboard, a mouse, a display unit (e.g. an LCD and/or LED indicator lamps), a microphone, a touch-sensitive display unit, a loudspeaker, a biometric sensor (e.g. a fingerprint sensor) and/or a camera.

The block diagram of an exemplary embodiment of the server 2B and/or the server 2C can correspond to the block diagram of the exemplary embodiment of the server 2A. The servers 2B and 2C are in particular set up to be able to store and manage a large number of data records. For this purpose the servers 2B and 2C for example have an extensive memory. Furthermore, the servers 2B and 2C can have further network interfaces, for example radio network interfaces for connection with the ship 10, the tractor unit 6 or the container 7.

FIG. 2b shows a block diagram of an exemplary embodiment of the client 4.

Processor 40 of client 4 performs program instructions, which are stored in the program memory 41, and stores for example intermediate results or similar in main memory 42. In addition processor 40 controls network interface 43, via which client 4 is able to connect with the network 5 (see FIG. 1).

Client 4 also comprises an input unit 44 and a display unit 45. Input unit 44 can for example accept user inputs and pass these to processor 40. Display unit 45 can receive and output information for the user from processor 40. Input unit 44 is preferably a mouse and/or keyboard, and display unit 45 is preferably a monitor.

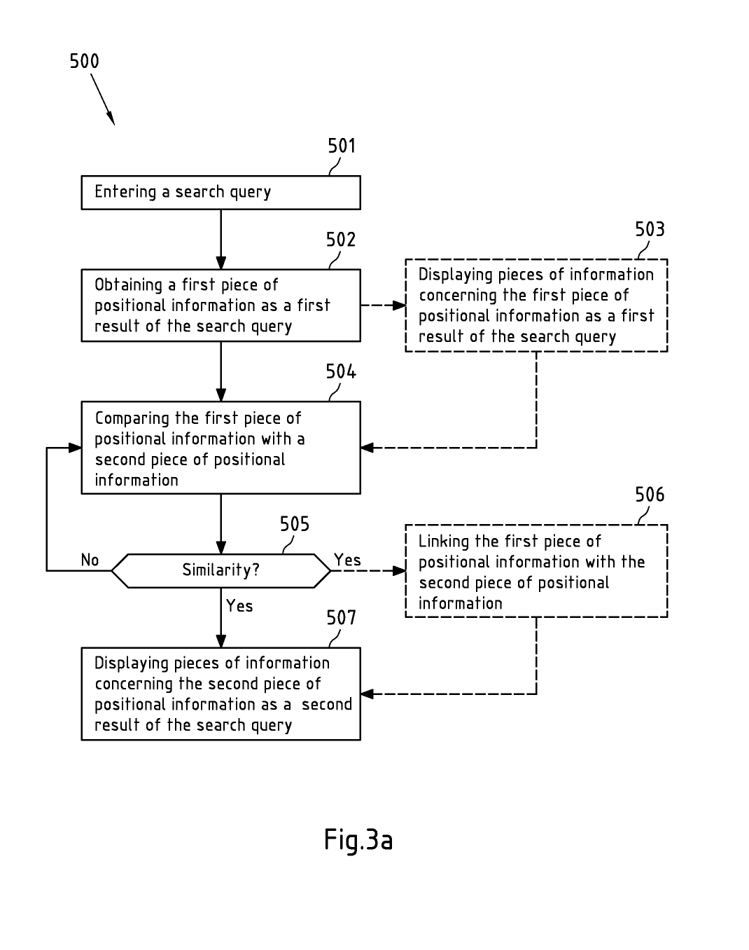

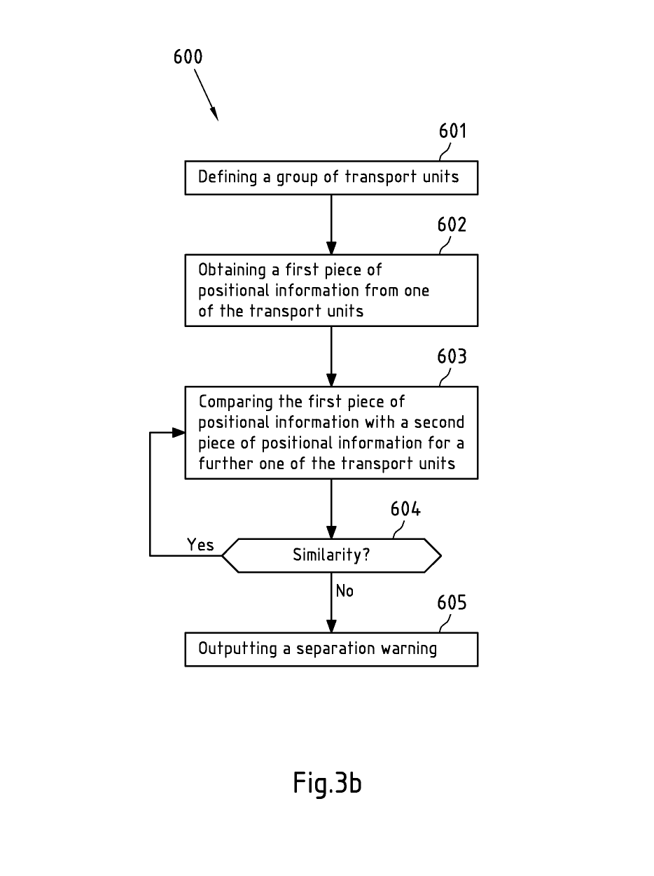

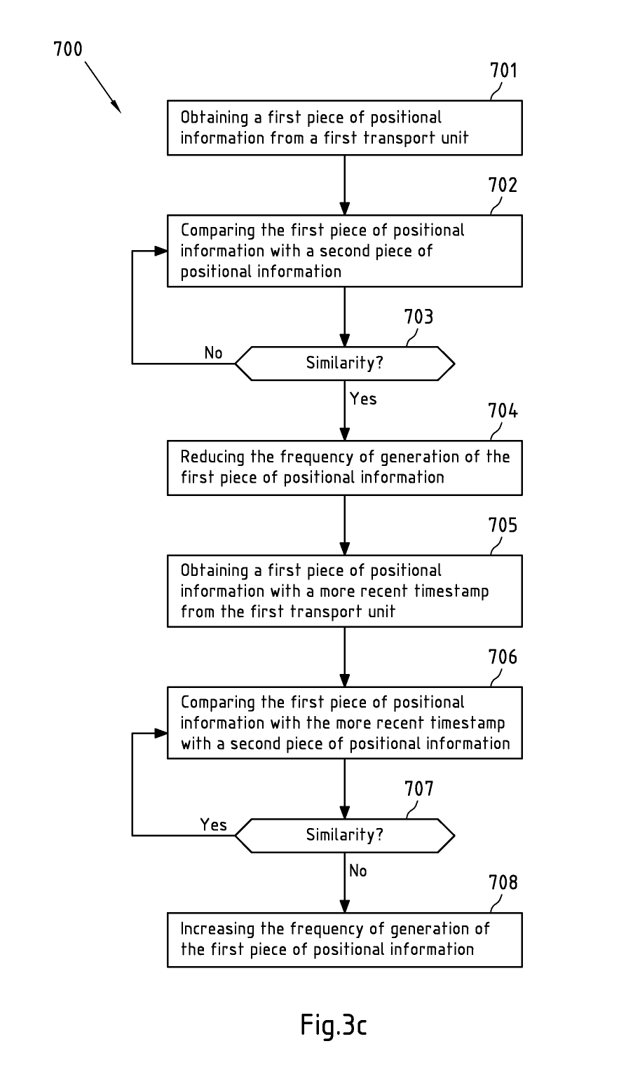

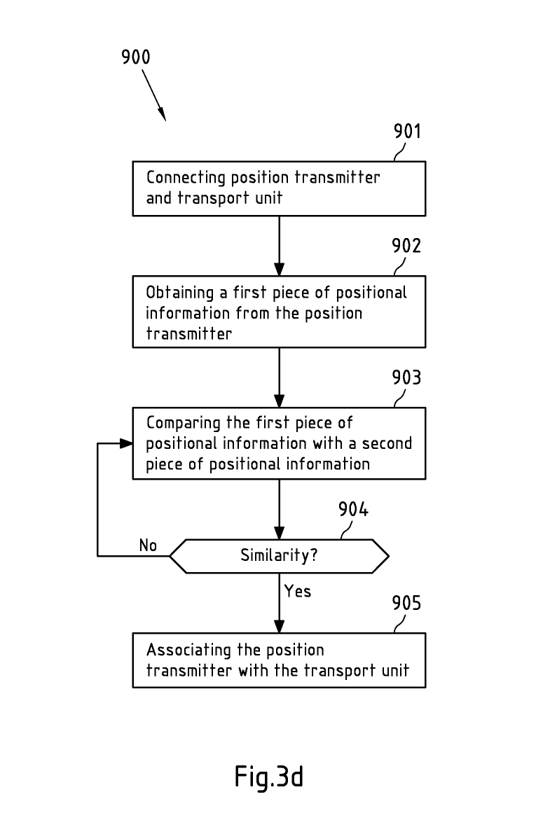

FIGS. 3a to 3d show flow diagrams 500, 600, 700 and 900 with process steps of exemplary embodiments of the method according to the invention. The steps in the flow diagrams, which can be performed by a program, shall in particular be understood in the sense that a program comprises corresponding program instructions, allowing an apparatus, on whose processor the program is run, to perform a corresponding step. To perform a step the processor can for example drive or control one or more corresponding means. Here the process steps of the flow diagram can be performed by a single apparatus only, or by a plurality of apparatuses (so the process steps and/or program instructions are then also performed by the respective processors of the apparatuses).

FIG. 3a shows a flow diagram 500 with process steps of an exemplary embodiment of the method according to the invention. The flow diagram 500 inter alia implements the first aspect of the invention, which for example implements an improved consignment tracking service for one or more users.

In a step 501 a user enters a search query. The user input takes place via the input unit 44 of the client 4. For example, the user enters the tracking number “0001” of the letter 8 as a search query. It is also conceivable for the user to enter a truncated search query, for example “000*”. The client sends the search query to the server 2A of the consignment tracking service provider. The server 2A sends the search query to the server 2B.

The server 2B processes the search query and sends one or more pieces of positional information, to which the search query relates, to the server 2A. The search query relates to a piece of positional information for example if it is assigned or can be assigned to a transport unit, to whose identifier (e.g. tracking number) the search query relates. In addition the search query can for example be automatically restricted to the piece of positional information that is assigned or can be assigned to a transport unit having the most recent timestamp.

The abovementioned search query “0001” relates for example only to the pieces of positional information of the letter 8 with the most recent timestamp. The truncated search query “000*” relates at least to the pieces of positional information of the letters 8 and 9 with the most recent timestamp in each case. If the search query from the user relates to a plurality of pieces of positional information, the servers send all corresponding pieces of positional information to the server 2A. If several pieces of positional information are sent to the server 2A, the subsequent steps 502 to 507 are for example performed for each piece of the positional information individually.

It is also conceivable that instead of the pieces of positional information, the data records containing the pieces of positional information, at least in part are sent to the server 2A. For the above-mentioned search query “0001” the server 2B for example sends the consignment tracking data record assigned to the letter 8 to the server 2A. In the consignment tracking data record the piece of positional information with the last scanning position of the letter 8 is stored. The last scanning position of the letter 8 is scanning position 11A.

In a step 502 the server 2A obtains a first piece of positional information as the first result of the search query by the user. The first piece of positional information is a piece of positional information received from the server 2B. For example, the first piece of positional information is the piece of positional information with the last scanning position of the letter 8.

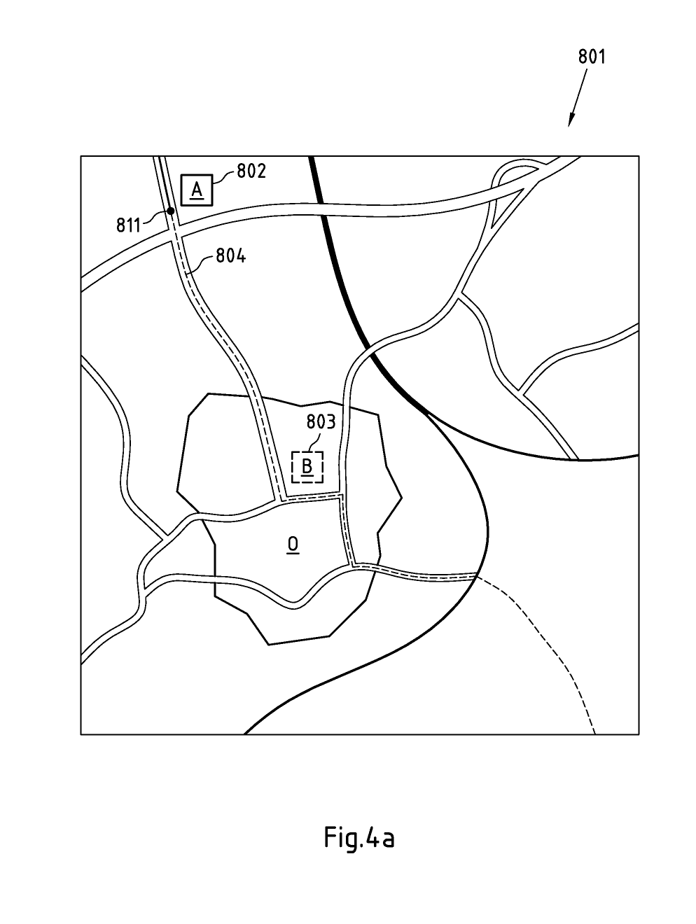

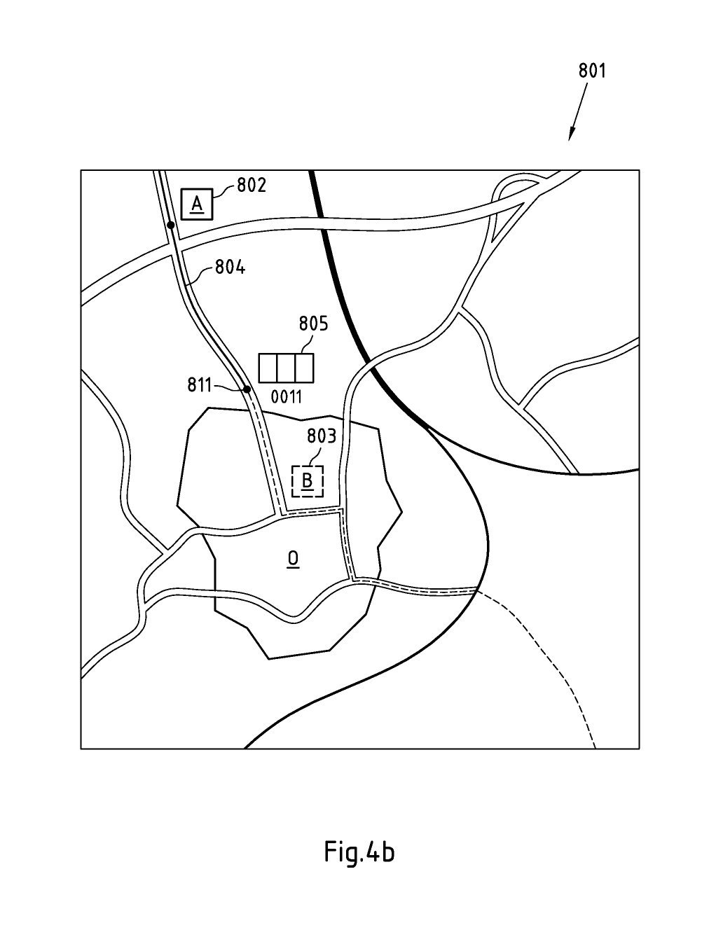

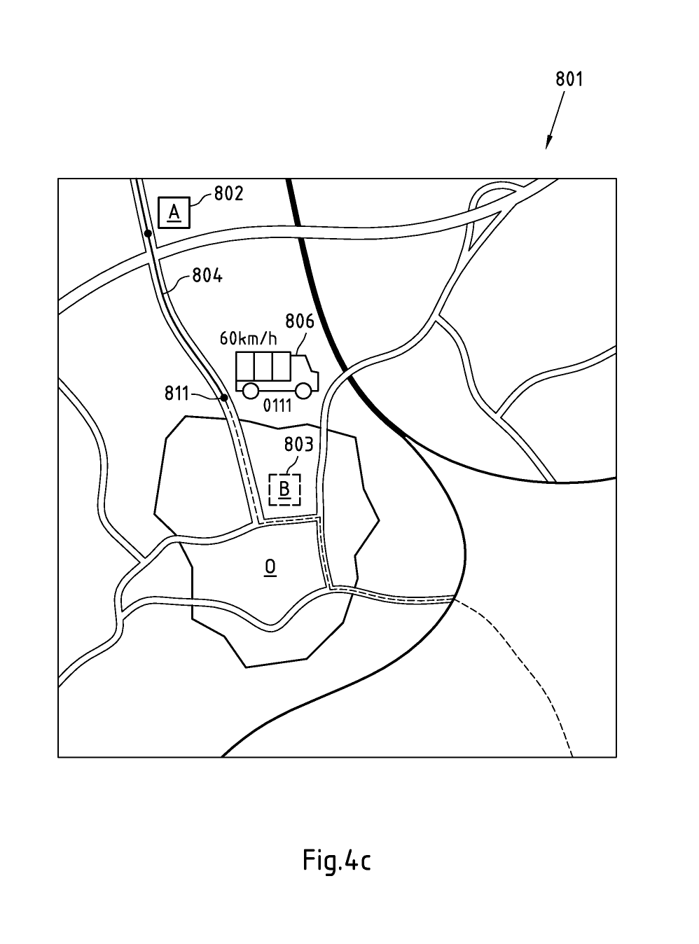

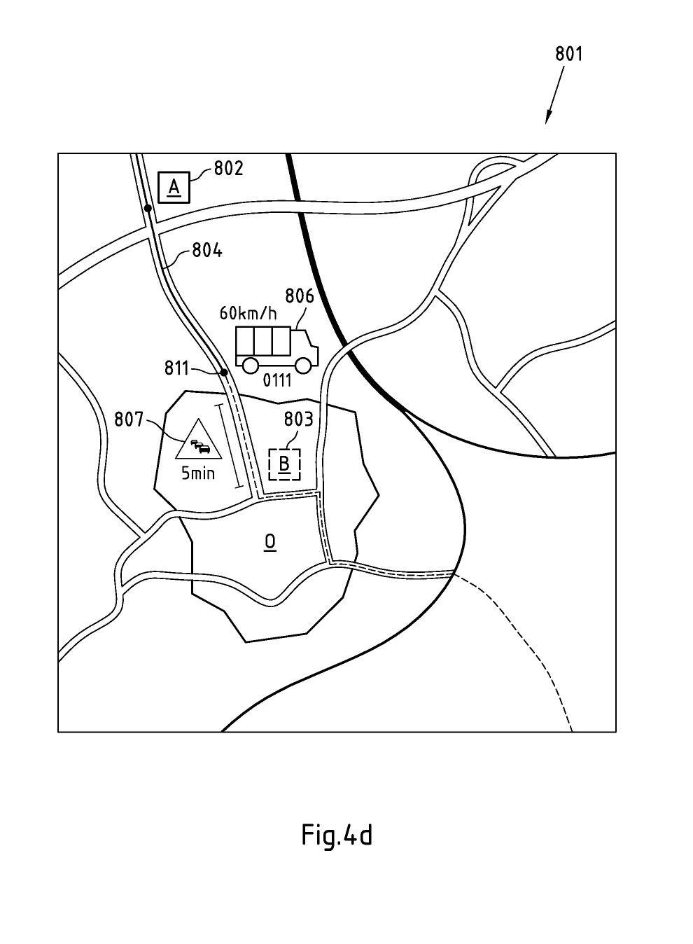

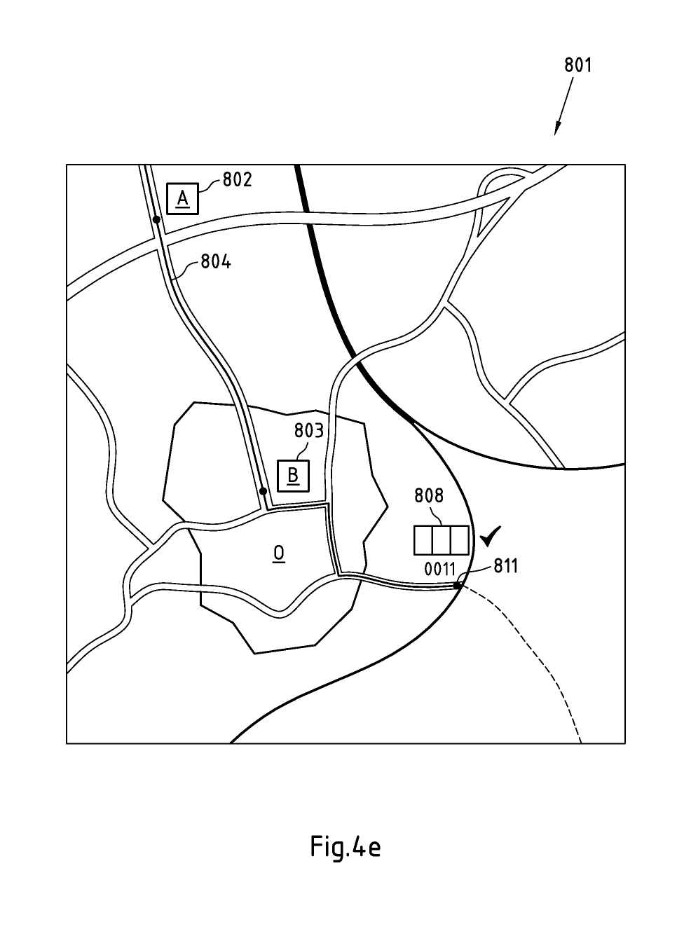

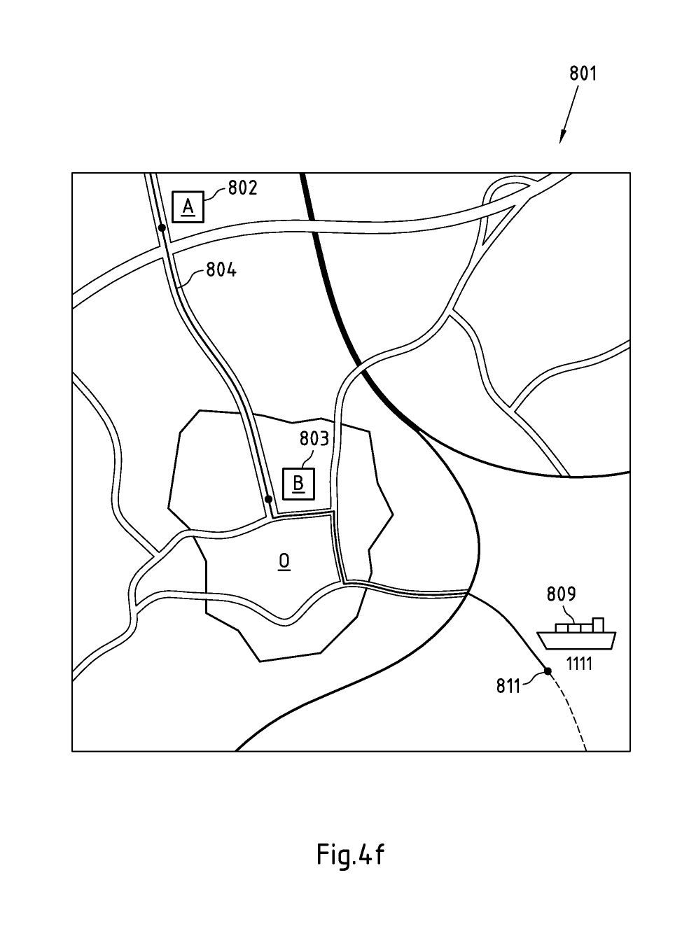

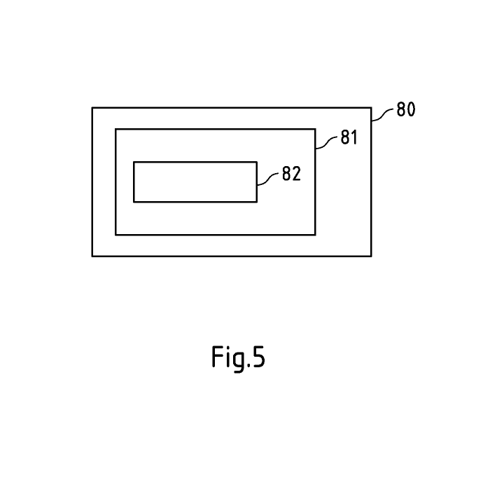

Then the server 2A can generate pieces of information concerning the first piece of positional information as the first result of the search query by the user and send these to the client 4. For example, the server 2A generates the pieces of information from the consignment tracking data record assigned to the letter 8 and sends this to the client 4. In an optional step 503 the pieces of information relating to the first piece of positional information are displayed to the user on the client 4 as the first result of the search query by the user. For example, the pieces of information are displayed to the user on a map extract at the position comprised in the first piece of positional information. For example, as a result of the above-mentioned search query the display shown in FIG. 4a and explained below is displayed to the user on the display unit 45 of the client 4.

Then the first piece of positional information is compared with a second piece of positional information in a step 504.

For this purpose the server 2A automatically sends a further search query relating to further pieces of positional information of relevance to the search query to the servers 2B and/or 2C. For example, the server 2A restricts the automatic search query to any of the servers and/or to pieces of positional information with a timestamp within a defined time interval around the timestamp of the first piece of positional information.

If the piece of positional information with the last scanning position of the letter 8 is the first piece of positional information, the server 2A for example sends an automatic search query relating to all further pieces of positional information with a timestamp within a time interval of 5 minutes around the last scanning time of the letter 8 to the server 2B. In this case server 2A does not send server 2C any search query for example, because the scanning position 11A is arranged at a container loading bay and only in the consignment tracking database on server 2B consignment tracking data records that are or can be assigned to containers are stored.

The servers 2B and/or 2C process the search query and send all further pieces of positional information, to which the search query relates, to the server 2A. It is also conceivable that instead of the further pieces of positional information the complete data records are sent to the server 2A.

The second piece of positional information is a further piece of positional information received from the servers 2B and/or 2C as a result of the automatic search query. If several further pieces of positional information are sent to the server 2A, for example each of the further pieces of positional information is individually compared with the first piece of positional information. Then for example the most similar second piece of positional information can be determined.

In a step 505 as a result of the comparison of the first piece of positional information with the second piece of positional information the server 2A checks if the first piece of positional information and the second piece of positional information are similar. The first piece of positional information and the second piece of positional information are similar, if the position comprised in the first piece of positional information is located in the vicinity of the position comprised in the second piece of positional information at least with a high probability. For example, the server 2A calculates a degree of similarity for the variables comprised in the first piece of positional information and the second piece of positional information. A similarity between the compared pieces of positional information is determined as a result of the comparison for example, if the degree of similarity exceeds a threshold. Otherwise as a result of the comparison for example no similarity between the pieces of positional information is determined. The threshold value is greater than or equal to 0.5, preferably the threshold value is 0.75 or 0.9.

For the above-mentioned search query, the first piece of positional information with the last scanning position of the letter 8 and the second piece of positional information are for example similar, if the last scanning position of the letter 8 is located at least within a radius of 10 metres around the position comprised in the second piece of positional information. This relates at least with a high probability only to the piece of positional information which is assigned or can be assigned to the container 7, in which the letter 8 was loaded at scanning position 11A.

In case that, as a result of the comparison in step 505, no similarity between the first piece of positional information and the second piece of positional information is determined, if a least one further piece of positional information is received from the servers 2B and/or 2C as a result of the automatic search query.

If as a result of the comparison in step 505, a similarity between the first piece of positional information and the second piece of positional information is determined, the first piece of positional information and the second piece of positional information are linked in an optional step 506. This can for example take place by a reference in the corresponding data records. If as a result of a plurality of individual comparisons a similarity has been determined, the linking can for example take place with the most similar second piece of positional information.

For example, the consignment tracking data record of the letter 8 can refer to the consignment tracking data record of the container 7, for example to the piece of positional information with the respective most recent timestamp of the container 7.

If as a result of the comparison in step 505 a similarity between the first piece of positional information and the second piece of positional information is determined, the server 2A then generates pieces of information concerning the second piece of positional information as the second result of the search query by the user and sends to this to the client 4. If as a result of a plurality of individual comparisons a similarity has been determined, the server 2A for example generates pieces of information concerning the most similar second piece of positional information.

For example, the server 2A generates the pieces of information from consignment tracking data record that is assigned or can be assigned to the container 7 and sends these to the client 4.

In a step 507 the pieces of information concerning the second piece of positional information are displayed to the user on the client 4 as the second result of the user's search query. For example, the pieces of information are displayed to the user on the map extract at the position comprised in the second piece of positional information. For example, the pieces of information are displayed in addition or alternatively to the pieces of information from the optional step 503. For example, as a result of the above-mentioned search query the display shown in FIG. 4b and explained below is displayed to the user on the display unit 45 of the client 4.

In FIG. 3b a flow diagram 600 with process steps of an exemplary embodiment of the method according to the invention is shown. The flow diagram 600 implements inter alia the second aspect of the invention, which for example implements isolation monitoring.

In a step 601 a group of transport units is defined. For example, the letter 8 and the letter 9 are sent together, so that for example automatically a group is formed by the letter 8 and the letter 9. This can for example take place by a corresponding piece of information in the consignment tracking data records that are or can be assigned to the letter 8 and the letter 9, for example by a reference.

In a step 602 a first piece of positional information is received from one of the transport units at the server 2A. As soon as the servers 2B and 2C receive a piece of positional information relating to a group of transport units, they pass this on for example to the server 2A. For example, the first piece of positional information is the last piece of positional information generated by the scanning position 11A for the letter 8.

Then the first piece of positional information is compared with a second piece of positional information from a further transport unit from the group of transport units in a step 603.

For this purpose the server 2A, similarly to how step 504 is performed, automatically sends a search query relating to further relevant pieces of positional information, which are or can be assigned to the further transport units from the group of transport units, to the server 2B and/or 2C. The search query comprises for example the tracking numbers of the further transport units from the group of transport units. For example, the server 2A restricts the automatic search query to any of the servers and/or to pieces of positional information with a timestamp within a defined time interval around the timestamp of the first piece of positional information. For example, the server 2A sends a search query relating to the piece of positional information that is assigned or can be assigned to the letter 9 with the most recent timestamp to the server 2B. It is also conceivable, that the server 2A sends the search query to the servers 2B and/or 2C with a delay (i.e. after receipt of the first piece of positional information initially waits for a certain interval of time). This is for example advantageous, if the pieces of positional information for the letters 8 and 9 cannot be generated simultaneously, for example because the letters cannot be scanned simultaneously.

The servers 2B and/or 2C process the search query and send all further pieces of positional information, to which the search query relates, to the server 2A. For the above-mentioned search query this is only the piece of positional information that is assigned or can be assigned to the letter 9 with the most recent timestamp. It is also conceivable that instead of the further pieces of positional information the complete data records are sent to the server 2A.

The second piece of positional information is a further piece of positional information received at server 2A from server 2B or 2C as a result of the automatic search query. If several further pieces of positional information are sent to the server 2A, for example each further piece of positional information is individually compared with the first piece of positional information.

In a step 604 as a result of the comparison of the first piece of positional information with the second piece of positional information, the server 2A determines if the first piece of positional information and the second piece of positional information are similar. The first piece of positional information and the second piece of positional information are, as stated above, similar, if the position comprised in the first piece of positional information (at least with a high probability) is located at least in the vicinity of the position comprised in the second piece of positional information. For the pieces of positional information that are or can be assigned to the letters 8 and 9 similarity then for example only exists if both were last scanned at the same scanning position.

If as a result of the comparison in step 604 a similarity between the first piece of positional information and the second piece of positional information is determined, if at least one further piece of positional information has been received from the servers 2B and/or 2C as a result of the automatic search query, step 603 is repeated for the further piece of positional information. This can be carried out for all transport units from the group of transport units.

If as a result of the comparison in step 604 no similarity between the first piece of positional information and the second piece of positional information is determined, in step 604 a isolation warning is issued to a user. For example, the user is informed of the tracking number of the isolated transport unit. For this purpose for example, through a comparison of the pieces of positional information of transport units from the group of all transport units, the transport unit can be identified which has been separated from the group of transport units, in particular if the group is formed of more than two transport units.

For example, the dispatcher responsible for the letters 8 and 9 is notified, for example by an automatically sent text message (SMS) and/or e-mail.

FIG. 3c shows a flow diagram 700 with process steps of an exemplary embodiment of the method according to the invention. The flow diagram 700 implements, inter alia, the third aspect of the invention, relating to a reduction in the frequency of generation of the first piece of positional information.

In a step 701 a first piece of positional information from a first transport unit is obtained at the server 2A. The first transport unit is for example a transport unit with a battery- and/or rechargeable battery-operated position transmitter. As soon as the servers 2B and 2C receive a piece of positional information relating to a transport unit with a battery-operated position transmitter, they pass this on for example to the server 2A.

It is also conceivable that the server 2A sends at regular intervals a search query relating to the pieces of positional information with the most recent timestamp in each case, which are or can be assigned to a transport unit with a battery-operated position transmitter, to the servers 2B and 2C. The servers 2B and 2C process the search query and send the pieces of positional information, to which the search query relates, to the server 2A. If several pieces of positional information are sent to the server 2A, the following steps 702 to 708 are for example carried out individually for each piece of positional information.

It is also conceivable that instead of the pieces of positional information the data records containing the pieces of positional information, at least in part, are sent to the server 2A.

The first piece of positional information is for example the last piece of positional information generated by the container 7.

In a step 702 the first piece of positional information is compared with a second piece of positional information.

For this purpose the server 2A, similarly as explained for steps 504 and 603, automatically sends a search query relating to further relevant positional information to the servers 2B and/or 2C. For example, the server 2A restricts the automatic search query to any of the servers and/or to pieces of positional information with a timestamp in a defined time interval around the timestamp of the first piece of positional information.

For example, the server 2A sends an automatic search query relating to all further pieces of positional information that are or can be assigned to a transport vehicle with a timestamp within a time interval of 1 second around the timestamp of the last piece of positional information generated by the container 7 to the server 2C. In this case the server 2A does not send the server 2B for example any search query, because only in the telematics database on server 2C pieces of positional information that are or can be assigned to a transport vehicle are stored.

The server 2B and/or 2C processes the search query and sends all further pieces of positional information, to which the search query relates, to the server 2A. It is also conceivable that instead of the further pieces of positional information the complete data records are sent to the server 2A.

The second piece of positional information is a further piece of positional information received from the servers 2B and/or 2C as a result of the automatic search query. If several further pieces of positional information are sent to the server 2A, for example each further piece of positional information is individually compared with the first piece of positional information.

In a step 703, as a result of the comparison of the first piece of positional information with the second piece of positional information, the server 2A determines if the first piece of positional information and the second piece of positional information are similar. The first piece of positional information and the second piece of positional information are, as stated above, similar, if the position comprised in the first piece of positional information (at least with a high probability) at least is located in the vicinity of the position comprised in the second piece of positional information.

For the above-mentioned search query the last piece of positional information generated by the container 7 and the second piece of positional information are for example similar, if the last position of the container is located at least within a radius of 10 metres around the position comprised in the second piece of positional information. This relates at least with a high probability only to the piece of positional information with the most recent timestamp that is assigned or can be assigned to the tractor unit 6 hauling the trailer with the container 7. In order to increase the accuracy, the comparison can for example be repeated one or more times for pieces of positional information of the container 7 with an older timestamp and corresponding pieces of positional information of the tractor unit 6.

If as a result of the comparison in step 703 a similarity between the first piece of positional information and the second piece of positional information is determined, in step 704 the frequency of generation of the first piece of positional information is reduced. Simultaneously the data record assigned to the first transport unit is for example linked to the data record assigned to the second transport unit.

For example, the server 2A and/or the server 2B sends a corresponding instruction to the position transmitter of the container 7. For example the position transmitter of the container 7 is instructed to generate a piece of positional information with the current position of the container only once per hour. At the same time, the consignment tracking data record assigned to the container 7 is for example linked with the telematics data record assigned to the tractor unit 6. For example, the consignment tracking data record of the container 7 can refer to the telematics data record of the tractor unit 6, for example to the piece of positional information with the respective most recent timestamp of the tractor unit 6. The reduction in the frequency of generation is, inter alia, advantageous, since the position transmitters of transport vehicles, such as the tractor unit 6, are normally not or at least not exclusively battery- and/or rechargeable battery-operated. In this way the battery-operated position transmitter of the container 7 can be spared, since the generation of the piece of positional information (due to the similarity of the first and second pieces of positional information) at least in part can be substituted by the at least not exclusively battery- and/or rechargeable battery-operated position transmitter of the tractor unit 6.

In a step 705 at the server 2A a first piece of positional information with a more recent timestamp is obtained from the first transport unit. As soon as the servers 2B and 2C receive a piece of positional information relating to the first transport unit, they pass this on for example to the server 2A. For example, the first piece of positional information with the more recent timestamp is the last piece of positional information generated by the container 7 (after the frequency of generation was reduced).

In a step 706 the first piece of positional information with the more recent timestamp is compared with a second piece of positional information. For example, the first piece of positional information with the more recent timestamp is compared with the piece of positional information of the second transport unit with the most recent timestamp. This is particularly simple, if the data records have been linked in step 704. Otherwise the server 2A must for example send a corresponding search query to the server 2B and/or the server 2C.

For example, the last piece of positional information generated by the container 7 (after the frequency of generation was reduced) is compared with the piece of positional information of the tractor unit 6 with the most recent timestamp.

In a step 706, as stated above concerning step 703, as a result of the comparison of the first piece of positional information with the more recent timestamp with the second piece of positional information the server 2A ascertains if the first piece of positional information and the second piece of positional information are similar.

If as a result of the comparison in step 706 no similarity between the first piece of positional information and the second piece of positional information is determined, in a step 708 the frequency of generation the first piece of positional information is increased again. Simultaneously for example the linking of the data records is reversed.

If as a result of the comparison in step 706 a similarity between the first piece of positional information and the second piece of positional information is determined, step 705 is repeated, as soon as a further first piece of positional information with a more recent timestamp is received from the first transport unit at the server 2A.

For example, for this purpose the server 2A and/or the server 2B send a corresponding instruction to the position transmitter of the container 7. Simultaneously the linking of the consignment tracking data record that is assigned or can be assigned to the container 7 with the telematics data record assigned to the tractor unit 6 is reversed.

FIG. 3d shows a flow diagram 900 with process steps of an exemplary embodiment of the method according to the invention. The flow diagram 900 implements, inter alia, the fourth aspect of the invention, which for example relates to the retrofitting of transport units with a position transmitter without the need for manual logical association of the position transmitter with the transport unit.

In a step 901 a position transmitter is linked with a transport unit. For example, the container 7 was not previously fitted with a position transmitter, but has for example been retrofitted with a position transmitter of the consignment tracking service provider. For example, the position transmitter is mounted on the container 7 permanently or at least temporarily. However, in the data record, which is assigned to the position transmitter, no information has been entered on the container, and/or in the data record, which is assigned to the container 7, no information has been entered on the position transmitter.

In a step 902 a first piece of information originating from a position transmitter is obtained at the server 2B. As soon as the server 2B receives a piece of positional information from a position transmitter, which is not assigned or cannot be assigned to a transport unit, it passes this on for example to the server 2A.

It is also conceivable that the server 2A at regular intervals sends a search query concerning such pieces of positional information, which are not or cannot be assigned to a transport unit, to the server 2B. The server 2B processes the search query and sends the pieces of positional information, to which the search query relates, to the server 2A. If a plurality of pieces of positional information are sent to the server 2A, the following steps 903 to 905 are for example performed individually for each piece of positional information.

It is also conceivable that instead of the pieces of positional information the data records containing the pieces of positional information at least in part are sent to the server 2A.

The first piece of positional information is for example the last piece of positional information generated by a position transmitter.

In a step 903 the first piece of positional information is compared with a second piece of positional information.

For this purpose the server 2A for example sends a search query relating to transport units, for which no pieces of positional information are stored in a data record in the consignment tracking database of the server 2B, to the server 2B. As a result of the automatic search query the server 2A receives from the server 2B for example the identifier of the corresponding transport units. For each of the transport units the server 2A can then—for example from a route planning system of the logistics company responsible for the transport unit—request the waypoints, which the transport unit should pass within a defined time interval around the timestamp of the first piece of positional information. For example, the server 2A can request from the route planning system the waypoints that the container 7 should pass on the day when the first piece of positional information was generated. The second piece of positional information is such a waypoint.

If several waypoints come into consideration for the comparison, the comparison can be performed individually for each of the waypoints. For example, the container 7 on the day should call at customers with numbers 99, 82, 45, 12, 2 and 81, so that corresponding waypoints (customer positions) come into consideration for the comparison.

In a step 904 as a result of the comparison of the first piece of positional information with the second piece of positional information the server 2A checks if the first piece of positional information and the second piece of positional information are similar. The first piece of positional information and the second piece of positional information are, as stated above, similar, if the position comprised in the first piece of positional information (at least with a high probability) is located at least in the vicinity of the position comprised in the second piece of positional information. For the containers 7 and the position transmitters there is for example then only similarity if the position comprised in the first piece of positional information corresponds with the waypoint, for example with the address of the corresponding customer.

For example, as a result of the comparison of the first piece of positional information with the address of the customer with the number 45 a similarity is determined.

If as a result of the comparison in step 904 no similarity between the first piece of positional information and the second piece of positional information is determined, if further waypoints come into consideration for the comparison, step 903 is repeated for the further waypoints.

If as a result of the comparison in step 904 a similarity between the first piece of positional information and the second piece of positional information is determined, the position transmitter is associated with the transport unit that is assigned or can be assigned to the second piece of positional information in step 905.

Alternatively for example it is conceivable that a similarity between at least a further first piece of positional information of the position transmitter and a second piece of positional information of the transport unit has to be determined, before the position transmitter is associated with the transport unit. The container 7 is for example only then associated with the position transmitter, if the position transmitter on the above-mentioned day also generated pieces of positional information for the customers with numbers: 99, 82, 12, 2 and 81. In this way it can be ensured at least with a high probability that the position transmitter has actually been mounted on the container 7.

In particular, the comparison can be continued until a transport unit comes into consideration. For example, at a depot of a logistics company on a first day ten swap bodies are retrofitted with position transmitters (step 901). On this day, a total of 100 swap bodies leave the depot. Of the 100 swap bodies, for example, three swap bodies were retrofitted with position transmitters. Of the remaining 97 swap bodies for example 47 swap bodies have already been fitted with a position transmitter and already been associated with the respective position transmitter.

For example, the position transmitters of the swap bodies in each case generate a first piece of positional information with geofencing data, for example upon entering and leaving geofencing areas. These first pieces of positional information are for example received at server 2B (step 902) and stored in the consignment tracking database of the server 2B. For example, the first retrofitted swap body travelled on the first day from the depot to Hamburg, stayed there for a day and then travelled on the third day to Bonn. For example, the first position transmitter, with which the first swap body was retrofitted, generated first pieces of positional information with corresponding geofencing data, which are stored in a data record that is assigned or can be assigned to the first position transmitter in the consignment tracking database of the server 2B.

In the subsequent days a check is made of where the swap bodies, which were located at the depot on the first day and are (still) not associated with a position transmitter, travelled to. These are the 50 swap bodies without position transmitters and the three retrofitted swap bodies. For this purpose the first pieces of positional information can for example be compared with the second pieces of positional information from a route planning system of the logistics company (step 903). For example, the first pieces of positional information are only compared with second pieces of positional information, which are or can be assigned to swap bodies, which are (still) not associated with a position transmitter. This is only the cased for the second pieces of positional information, which are or can be assigned to the three retrofitted swap bodies and the 50 swap bodies without position transmitters. Through the comparison it is for example determined that 53 of the swap bodies considered were or should have been located in the depot on the first day (step 904). The first position transmitter can only be mounted on one of the 53 swap bodies, however, so that the comparison is continued (iteratively) for these 53 swap bodies or for second pieces of positional information of the 53 swap bodies.

For example, through a further comparison it is determined (steps 903 and 904), that only five of the 53 swap bodies travelled or should have travelled to Hamburg (or in a geofencing area for Hamburg) on the first day. Of the 53 swap bodies thus 48 swap bodies can be excluded, so that the comparison is continued only with second pieces of positional information from the route planning system for the remaining five swap bodies. For example, only three out of the five swap bodies should have remained in Hamburg on the second day, and only one of these three swap bodies should for example have travelled to Bonn on the third day. Only through the comparison of the first pieces of positional information of the position transmitter (with the geofencing data for the depot and Hamburg on the first day, Hamburg on the second day and Bonn on the third day) with the second pieces of positional from the route planning system (with waypoints or geofencing data for the depot and Hamburg on the first day, Hamburg on the second day and Bonn on the third day), which are or can be assigned to the first retrofitted swap body, it can thus be positively determined that this swap body was retrofitted with the first position transmitter. The first swap body is then associated with the first position transmitter (step 905).

The association of the position transmitter with the transport unit takes place for example by a linking of the consignment tracking data record of the transport unit with the consignment tracking data record of the position transmitter, for example by a reference in the corresponding data records. For example, the consignment tracking data record of the container 7 can refer to the consignment tracking data record of the position transmitter, for example to the piece of positional information with the most recent timestamp of the position transmitter in each case.

Unlike the procedure described above, previously when “marrying up” assets, such as for example transport units, with position transmitters, in a very cost- and time-intensive manual manner, for example using a barcode scanner, a logical link had to be created between the asset and the position transmitter. Through the comparison according to the invention of the pieces of positional information however (for example after a successful functional test), a position transmitter can easily be linked with a transport unit (for example a container), for example mounted on any transport unit, without a manual logical linking being necessary.

FIGS. 4a to 4f show schematic representations of a map extract 801 displayed on the display unit 45 of the client 4.

The map extract 801 shows the position of the location O and its environment. In the environment of the location A, map extract 801 shows inter alia streets, a river and an ocean.

On the map extract in FIGS. 4a to 4f, various pictograms are arranged. The pictograms are in each case arranged in a positionally accurate manner according to the position of the assigned unit on the map extract 801 and for example contain pieces of information concerning the unit. The type of unit can for example be inferred from the graphic representation of the pictogram.

The displays shown in FIGS. 4a to 4f are displayed to a user of the client 4 for example as a result of a search query relating to the letter 8. The display is for example generated by the server 2A, as stated for step 503, and provided for display on the client 4, for example as a displayable graphic. The server 2A generates the display for example from the consignment tracking data record of the letter 8 and/or further data records and the corresponding map extract.

The display shown in FIG. 4a is displayed to the user for example as the first result of the search query relating to the letter 8. On the map extract 801 in FIG. 4a a pictogram 802 is arranged. The pictogram 802 is assigned to the scanning position 11A. The position 811 of the letter 8 (with a granularity which initially corresponds to the first result of the search query) is arranged on the map extract at scanning position 11A. Furthermore, on the map extract 801 in FIG. 4a the planned route 804 of the letter 8 is shown as a dashed line. The planned route 804 can inter alia be inferred from the consignment tracking data record of the letter 8, for example from a destination indicated therein, and/or for example from a request to a route planning system of the logistics company responsible. It is also conceivable that the planned route 804 is not inferred from the consignment tracking data record. In this case for example neither the route 804 nor the pictogram 803 could be displayed.

The display shown in FIG. 4a is generated by the server 2A for example as the first result of the search query “0001” from the consignment tracking data record and provided for display on the client 4, when the letter has already passed the scanning position 11A. Merely for illustration, in FIG. 4a also the next scanning position 11B is shown with the pictogram 803 as a dashed line, in order to illustrate the relatively low local resolution of a consignment tracking service based solely on scanning positions.

Thus as the first result of the search query the user receives only the pieces of information that are stored in the consignment tracking data record, which relate to the scanning positions in the delivery chain. The position 811 shown of the letter 8 is very imprecise here because of the large distances between the scanning positions. By applying the comparison as described for example in step 504, the information content can be increased enormously however. This can be seen for example in the displays shown in FIGS. 4b to 4f, which are displayed to the user for example as the second result of the search query relating to the letter 8.

In the display shown in FIG. 4b, the pictogram 805 is arranged on the map extract 801 next to the pictogram 802, the position 811 and the planned route 804. The pictogram 805 is a container pictogram assigned to the container 7. Next to the pictogram 805, the inventory number “0011” of the container 7 is shown. The pictogram 805 and the position 811 of the letter 8 are arranged on the map extract 801 in dependence on the last-known position of the container 7. Here the position displayed reflects the actual position of the letter much more accurately than in FIG. 4a, since the container 7 generates a piece of positional information at regular time intervals and sends it to the server 2B.

The display shown in FIG. 4b is generated by the server 2A for example as the second result of the search query from the consignment tracking data record of the letter 8 and the consignment tracking data record of the container 7 and provided for display on the client 4, if it transpires from the comparison (e.g. in step 504) that the letter 8 was loaded in container 7.

In the display shown in FIG. 4c, the pictogram 806 is arranged on the map extract 801 instead of the pictogram 805. The pictogram 806 is an HGV pictogram assigned to the tractor unit 6. Next to the pictogram 806, the chassis number “0111” of the tractor unit and the current speed “60 km/h” are shown. The pictogram 806 is arranged according to the last-known position of the tractor unit 6 on the map extract 801.

The display shown in FIG. 4c is generated by the server 2A for example as the second result of the search query from the consignment tracking data record of the letter 8 and the telematics data record of the tractor unit 6 and provided for display on the client 4, if it transpires from the comparison (e.g. in step 504) that the letter 8 and/or the container 7 is being transported by the tractor unit 6. By means of this piece of information for example additionally the loading condition, the vehicle type and the average consumption of the tractor unit is or can be displayed to the user. For example, the pictogram 806 can be activated so that upon activation further pieces of information can be displayed for selection. The further pieces of information can for example be generated by the server 2A, if the user selects them. For example, the server 2A can calculate, with the help of the pieces of information from the telematics data record of the tractor unit 6, such as load and consumption, and the consignment tracking data record of the letter 8, such as weight and size, the CO₂ emissions actually generated by the transport of the letter 8 and provide this for display. In addition, for example, the expected time of arrival (of the tractor unit 6 at the destination) can be calculated with the help of historic pieces of positional information in the telematics data record of the tractor unit 6.

In the display shown in FIG. 4d, the pictogram 807 is arranged on the map extract 801 next to the pictograms 802 and 806, the position 811 and the planned route 804. The pictogram 807 is a traffic hold-up pictogram assigned to traffic congestion. Next to the pictogram 807, the expected delay (“5 min”) by the traffic hold-up is displayed.

The display shown in FIG. 4d is generated by the server 2A for example as the second result of the search query from the consignment tracking data record of the letter 8 and the telematics data record of the tractor unit 6 and provided for display on the client 4, if it transpires from the comparison (e.g. in step 504) that the letter 8 and/or the container 7 is or are being transported by the tractor unit 6 and that on the planned route 804 there is a traffic hold-up of relevance to the tractor unit 6. The planned route 804 can for example be identified by querying the route planning system of the responsible logistics company. For example, the server 2A can also query the pieces of positional information of the transport vehicles, which are located on the planned route 804, and can for example derive the traffic situation from the current speed of the vehicles travelling in front , for example the vehicles travelling in front from the fleet of the logistics company responsible for the letter 8. In addition, a query to a congestion warning system, such as for example the Traffic Message Channel (TMC or TMC Pro), can take place.

In the display shown in FIG. 4e, the pictogram 808 is arranged on the map extract 801 next to the pictograms 802 and 803, the position 811 and the planned route 804. The second scanning position 11B has in the meantime been passed and is therefore similarly shown as pictogram 803. Pictogram 808 is a container pictogram assigned to the container 7. Next to the pictogram 808 the inventory number “0011” of the container 7 is displayed. In addition, next to the pictogram 808, a tick is displayed. The pictogram 808 and the position 811 of the letter 8 are arranged on the map extract 801 in accordance with the last-known position the container 7.

The display shown in FIG. 4e is generated by the server 2A for example as the second result of the search query from the consignment tracking data record of the letter 8 and the consignment tracking data record of the container 7, and is provided for display on the client 4, if it transpires from the comparison (e.g. in step 504) that the letter 8 was loaded in container 7 and the container is located at the envisaged container point in the port of trans-shipment. The tick displayed next to the pictogram 808 symbolises here that the container 7 is positioned in the correct location.

Once the container 7 arrives at the port together with the tractor unit 6, the pieces of positional information of the container 7 are for example compared with the port's internal management systems, for example with pieces of positional information from a container point database. As soon as it transpires from the comparison (e.g. in step 504) that the container 7 is located at a container point, the pictogram on the map changes from the HGV pictogram to the container pictogram 808. Furthermore, for example, further pieces of information from the port's internal management systems can be displayed or displayable. For example, the pictogram 808 can be activated so that upon activation further pieces of information can be displayed for selection. The further pieces of information can for example be generated by the server 2A, if the user selects them. For example, the server 2A can provide the image from a monitoring camera for the container point for display. Upon trans-shipment of the container 7 to an aircraft, a similar process can be followed. In addition, however, further pieces of information can be displayed or displayable (e.g. the route of the dollies/transport vehicles at the airport).

In the display shown in FIG. 4f, the pictogram 809 is arranged on the map extract 801 next to the pictograms 802 and 803, the position 811 and the planned route 804. The pictogram 809 is a pictogram assigned to the container ship 10. Next to the pictogram 809 the identifier “1111” of the ship 11 is shown. The pictogram 809 and the position 811 of the letter 8 are arranged in dependence on the last-known position of the ship 10 on the map extract 801.

The display shown in FIG. 4f is generated by the server 2A for example as the second result of the search query from the consignment tracking data record of the letter 8 and the consignment tracking data record of the container 7 and provided for display on the client 4, if it transpires from the comparison (e.g. in step 504) that the letter 8 was loaded in container 7 and the container 7 is being transported by the ship 10.

To this end, the data of the forwarder, concerning the ship on which the container is to be loaded, are compared with the pieces of positional information (e.g. the AIS data) of all relevant container ships, and an advance linking is performed. Should the pieces of positional information of the container 7 begin to correspond with the pieces of positional information of the ship 10 (e.g. roughly similar speed, similar direction of movement, similar position and/or similar velocity vector), then the data records of the container 7 and of the ship 10 are linked together (e.g. combined), and instead of the container pictogram, a ship pictogram 809 is displayed. In addition, a switch can be made from a land map view to a sea map view, since now it can be assumed that the consignment is at sea.

In addition, for example further AIS pieces of information can be displayed or be displayable. For example, the pictogram 809 can be activated so that upon activation further pieces of information are displayed for selection. The further pieces of information can for example be generated by the server 2A, if the user selects them. Should the planned route pass through a storm area, then server 2A can be queried for storms on the actual path taken by the ship 10 and corresponding pieces of information provided for display on the client 4. Thus global weather data does not need to be displayed, only that which is relevant to the user. The planned route can inter alia result from the historical pieces of positional information stored in the telematics data record of the ship 10.

FIG. 5 shows a block diagram of an exemplary embodiment of a storage medium 80 according to the invention. The storage medium is preferably a machine-readable storage medium. The storage medium can in particular be a physical and/or tangible storage medium, which can be read by at least one of the servers 2A, 2B and 2C and/or the client 4.

The storage medium 80 comprises a program 81 with program instructions 82. The program instructions 82 cause an apparatus to perform at least some of the steps of the flow diagrams 500, 600, 700 and 900 at least in part, if the program is run on a processor of the apparatus. For example, the program is executable at least on one of the processors 20 and 40.

The sequence of the method steps described in this specification in the individual flow diagrams is not mandatory, alternative sequences of the method steps are conceivable. The method steps can be implemented in various ways, with implementation by software (through program instructions), hardware or a combination of the two for implementation of the process steps being conceivable.

1. Method, performed by at least one apparatus, the method comprising:
comparing a first piece of positional information with at least a second piece of positional information,
wherein the first piece of positional information is one of assigned and assignable to one of a first transport unit and a unit for generating pieces of positional information, wherein the second piece of positional information is one of assigned and assignable to one of a second transport unit and a location of a transport unit, and wherein at least one of (i) and (ii) holds:
(i) if as a result of the comparison a similarity between the first piece of positional information and the second piece of positional information is determined, performing at least one of:
associating one of the first transport unit and the unit for generating pieces of positional information with one of the second transport unit and the location and
influencing the generation of one of the first piece of positional information and the second piece of positional information,
(ii) if as a result of the comparison no similarity between the first piece of positional information and the second piece of positional information is determined, performing at least one of:
outputting a piece of information concerning the result of the comparison and
influencing the generation of one of the first positional information and the second piece of positional information.

2. Method according to claim 1, wherein each piece of positional information that is one of assigned and assignable to a transport unit comprises a position of the transport unit and wherein each piece of positional information that is one of assigned and assignable to the unit for generating pieces of positional information comprises a position of the unit for generating pieces of positional information.

3. Method according to claim 1, wherein the first piece of positional information is generated by one of a control unit, the first transport unit and the unit for generating pieces of positional information, and wherein the second piece of positional information is generated by the second transport unit.

4. Method according to claim 1, wherein a data record is one of assigned and assignable to one of
each transport unit and
the unit for generating pieces of positional information,
wherein each data record comprises at least one piece of positional information, and wherein one of the first transport unit and the unit for generating pieces of positional information is one of assigned and assignable a first data record with the first piece of positional information, and wherein the second transport unit is one of assigned and assignable a second data record with the second piece of positional information.

5. Method according to claim 4, wherein the associating comprises:
at least in part linking of the first data record with the second data record, wherein the first data record in particular is linked with the second data record so that the first data record at least comprises a reference to the second piece of positional information.

6. Method according to claim 1, further comprising:
obtaining a search query by a user concerning the first transport unit,
enriching pieces of information concerning the first transport unit with pieces of information concerning one of the second transport unit and the location, if as a result of the comparison a similarity between the first piece of positional information and the second piece of positional information is determined, and
outputting the enriched pieces of information concerning the first transport unit as the result of a search query.

7. Method according to claim 6, wherein the first transport unit is a consignment, and wherein the second transport unit is one of a transport container and a transport vehicle for the consignment, and wherein the pieces of information concerning the consignment are enriched with pieces of telematics information concerning one of the transport container and the transport vehicle.

8. Method according to claim 1, further comprising at least one of:
reducing a frequency, with which at least one of the first piece of positional information and second piece of positional information is/are generated, if as a result of the comparison a similarity between the first piece of positional information and the second piece of positional information is determined, and
increasing the frequency, if as a result of the comparison no similarity between the first piece of positional information and the second piece of positional information is determined.

9. Method according to claim 1, wherein the first transport unit is a first individual consignment and the second transport unit is a second individual consignment, wherein the first individual consignment and the second individual consignment are dispatched together, and wherein an isolation alarm is activated, if as a result of the comparison no similarity between the first and the second piece of positional information is determined.

10. System comprising
one or more apparatuses configured to perform the method according to claim 1.

11. Tangible storage medium comprising a program with program instructions, the program instructions causing a processor to perform the following, when the program is run on the processor:
comparing a first piece of positional information with at least a second piece of positional information,
wherein the first piece of positional information is one of assigned and assignable to one of a first transport unit and a unit for generating pieces of positional information, wherein the second piece of positional information is one of assigned and assignable to one of a second transport unit and a location of a transport unit,
the program instructions further causing the processor to perform at least one of (i) and (ii), when the program is run on the processor:
(i) if as a result of the comparison a similarity between the first piece of positional information and the second piece of positional information is determined, performing at least one of:
associating one of the first transport unit and the unit for generating pieces of positional information with one of the second transport unit and the location and
influencing the generation of one of the first piece of positional information and the second piece of positional information,
(ii) if as a result of the comparison no similarity between the first piece of positional information and the second piece of positional information is determined, performing at least one of:
outputting a piece of information concerning the result of the comparison and
influencing the generation of one of the first positional information and the second piece of positional information.

12. Apparatus comprising at least a processor and a memory, the memory storing a program comprising program instructions, wherein the memory and the program are configured to, with the processor, to cause the apparatus at least to perform the following, when the program is run on the processor:
comparing a first piece of positional information with at least a second piece of positional information,
wherein the first piece of positional information is one of assigned and assignable to one of a first transport unit and a unit for generating pieces of positional information, wherein the second piece of positional information is one of assigned and assignable to one of a second transport unit and a location of a transport unit, wherein the memory and the program are further configured to, with the processor, to cause the apparatus at least to perform at least one of (i) and (ii), when the program is run on the processor:
(i) if as a result of the comparison a similarity between the first piece of positional information and the second piece of positional information is determined, performing at least one of:
associating one of the first transport unit and the unit for generating pieces of positional information with one of the second transport unit and the location and
influencing the generation of one of the first piece of positional information and the second piece of positional information,
(ii) if as a result of the comparison no similarity between the first piece of positional information and the second piece of positional information is determined, performing at least one of:
outputting a piece of information concerning the result of the comparison and
influencing the generation of one of the first positional information and the second piece of positional information.

13. Apparatus according to claim 12, wherein each piece of positional information that is one of assigned and assignable to a transport unit comprises a position of the transport unit and wherein each piece of positional information that is one of assigned and assignable to the unit for generating pieces of positional information comprises a position of the unit for generating pieces of positional information.

14. Apparatus according to claim 12, wherein the first piece of positional information is generated by one of a control unit, the first transport unit and the unit for generating pieces of positional information, and wherein the second piece of positional information is generated by the second transport unit.

15. Apparatus according to claim 12, wherein a data record is one of assigned and assignable to one of
each transport unit and
the unit for generating pieces of positional information,
wherein each data record comprises at least one piece of positional information, and wherein one of the first transport unit and the unit for generating pieces of positional information is one of assigned and assignable a first data record with the first piece of positional information, and wherein the second transport unit is one of assigned and assignable a second data record with the second piece of positional information.

16. Apparatus according to claim 12, wherein the associating comprises:
at least in part linking of the first data record with the second data record, wherein the first data record in particular is linked with the second data record so that the first data record at least comprises a reference to the second piece of positional information.

17. Apparatus according to claim 12, wherein the memory and the program are further configured to, with the processor, cause the apparatus at least to perform the following, when the program is run on the processor:
obtaining a search query by a user concerning the first transport unit,
enriching pieces of information concerning the first transport unit with pieces of information concerning one of the second transport unit and the location, if as a result of the comparison a similarity between the first piece of positional information and the second piece of positional information is determined, and
outputting the enriched pieces of information concerning the first transport unit as the result of a search query.

18. Apparatus according to claim 17, wherein the first transport unit is a consignment, and wherein the second transport unit is one of a transport container and a transport vehicle for the consignment, and wherein the pieces of information concerning the consignment are enriched with pieces of telematics information concerning one of the transport container and the transport vehicle.

19. Apparatus according to claim 12, wherein the memory and the program are further configured to, with the processor, cause the apparatus at least to perform at least one the following, when the program is run on the processor:
reducing a frequency, with which at least one of the first piece of positional information and second piece of positional information is/are generated, if as a result of the comparison a similarity between the first piece of positional information and the second piece of positional information is determined, and
increasing the frequency, if as a result of the comparison no similarity between the first piece of positional information and the second piece of positional information is determined.

20. Apparatus according to claim 12, wherein the first transport unit is a first individual consignment and the second transport unit is a second individual consignment, wherein the first individual consignment and the second individual consignment are dispatched together, and wherein an isolation alarm is activated, if as a result of the comparison no similarity between the first and the second piece of positional information is determined.
